(19) United States
(12) Patent Application Publication
(10) Pub. No.: US 2026/0178169 A1
(43) Pub. Date: Jun. 25, 2026

(54) INTEGRATING WEB CONTENT

(71) Applicant: Apple Inc., Cupertino, CA (US)

(72) Inventors: Kirk P. MUELLER, San Francisco, CA (US); Emmet R. SMITH, San Jose, CA (US); Rondi J. MASTERS, San Jose, CA (US)

(21) Appl. No.: 19/542,317

(22) Filed: Feb. 17, 2026

Related U.S. Application Data
(60) Provisional application No. 63/759,999, filed on Feb. 18, 2025.

(51) Int. Cl. G06F 3/0482; G06F 3/0484; G06F 9/451

(52) U.S. Cl. CPC G06F 3/0482; G06F 3/0484; G06F 9/451

(57) ABSTRACT

The present disclosure generally relates to manipulating web-based content. Some techniques are for manipulating content from a webpage in accordance with some embodiments. Other techniques are for automatically integrating web-based content into an application in accordance with some embodiments.

### CROSS-REFERENCE TO RELATED APPLICATIONS

This application claims priority to U.S. Provisional Patent Application Ser. No. 63/759,999, entitled “Integrating Web Content,” filed Feb. 18, 2025. The content of this application is hereby incorporated by reference in their entirety.

### FIELD

The present disclosure relates generally to computer user interfaces, and more specifically to techniques for manipulating web-based content.

### BACKGROUND

Electronic devices often receive content from a variety of sources. Such content can include existing formatting and/or extraneous information. For example, a webpage can include formatting that is hard to read and/or configured for alternative functions such as advertising. Therefore, there is a need for improved techniques for manipulating web-based content.

### SUMMARY

Some techniques for manipulating web-based content using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for manipulating web-based content. Such processes and interfaces optionally complement or replace other processes for manipulating web-based content. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more display generation components is described. In some embodiments, the method comprises: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a computer system configured to communicate with one or more input devices and one or more display generation components is described. In some embodiments, the computer system comprises means for performing each of the following steps: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: displaying, via the one or more display generation components, a first user interface of a first application, wherein the first user interface includes one or more items; while displaying, via the one or more display generation components, a second user interface of the first application, detecting, via the one or more input devices, an input (1) directed to the second user interface and (2) corresponding to a request to save the one or more items; in response to detecting the input corresponding to the request to save the one or more items, displaying, via the one or more display generation components, an indication corresponding to the one or more items; while displaying the indication corresponding to the one or more items, detecting, via the one or more input devices, an input corresponding to the indication; and in response to detecting the input corresponding to the indication, displaying, via the one or more display generation components, a user interface of a second application different from the first application, wherein the user interface of the second application includes: a representation of the one or more items; and a representation of one or more other items not included in the one or more items.

In some embodiments, a method that is performed at a computer system that is in communication with one or more input devices and one or more display generation components is described. In some embodiments, the method comprises: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

In some embodiments, a transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

In some embodiments, a computer system configured to communicate with one or more input devices and one or more display generation components is described. In some embodiments, the computer system comprises means for performing each of the following steps: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: displaying, via the one or more display generation components, a first user interface of a first application, wherein the first user interface includes content; after displaying the first user interface of the first application, detecting, via the one or more input devices, an input corresponding to a request to display a user interface of a second application different from the first application; and in response to detecting the input corresponding to the request to display a user interface of the second application, displaying, via the display generation component, a second user interface of the second application, wherein: in accordance with a determination that display of the content satisfies a first set of one or more criteria, the second user interface includes an indication of the content; and in accordance with a determination that display of the content satisfies a second set of one or more criteria, the second user interface does not include the indication of the content, wherein the second set of one or more criteria is different from the first set of one or more criteria.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for manipulating web-based content, thereby increasing the effectiveness, efficiency, and user satisfaction with such devices. Such processes and interfaces may complement or replace other processes for manipulating web-based content.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6N illustrate exemplary user interfaces for interacting with web-based content across multiple applications in accordance with some embodiments.

FIG. 7 is a flow diagram illustrating a process for manipulating content from a webpage in accordance with some embodiments.

FIG. 8 is a flow diagram illustrating a process for automatically integrating web-based content into an application in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for manipulating web-based content. For example, web-based content can be added to an existing list within another application to provide additional functionality to the web-based content. For another example, web-based content can be automatically integrated within an application based on a user's interactions with the web-based content. Such techniques can reduce the cognitive burden on a user who view web-based content, thereby enhancing productivity. Further, such techniques can reduce processor and battery power otherwise wasted on redundant user inputs.

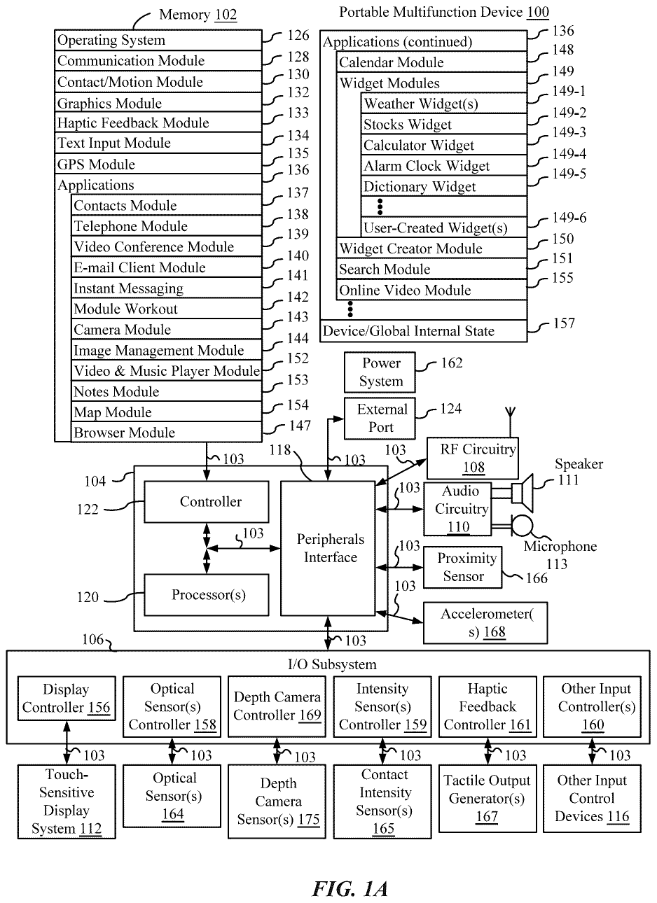

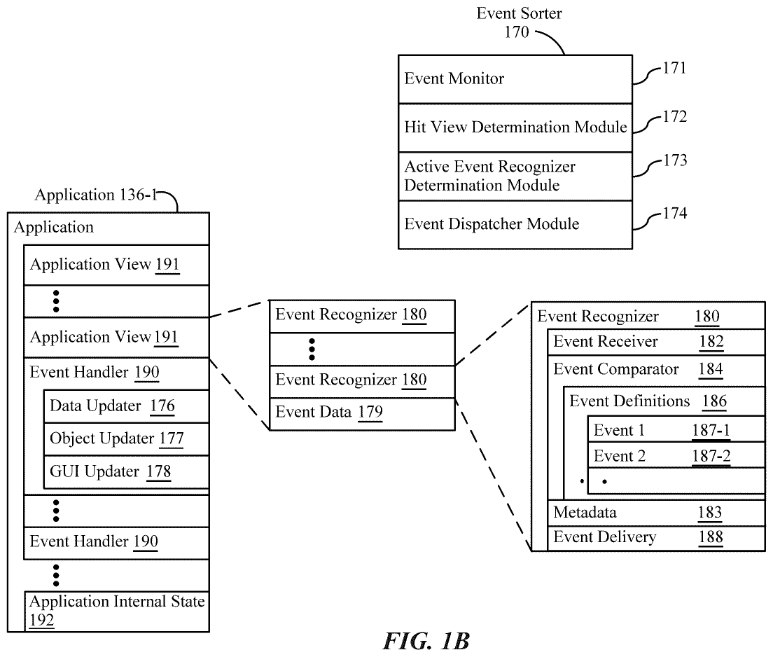

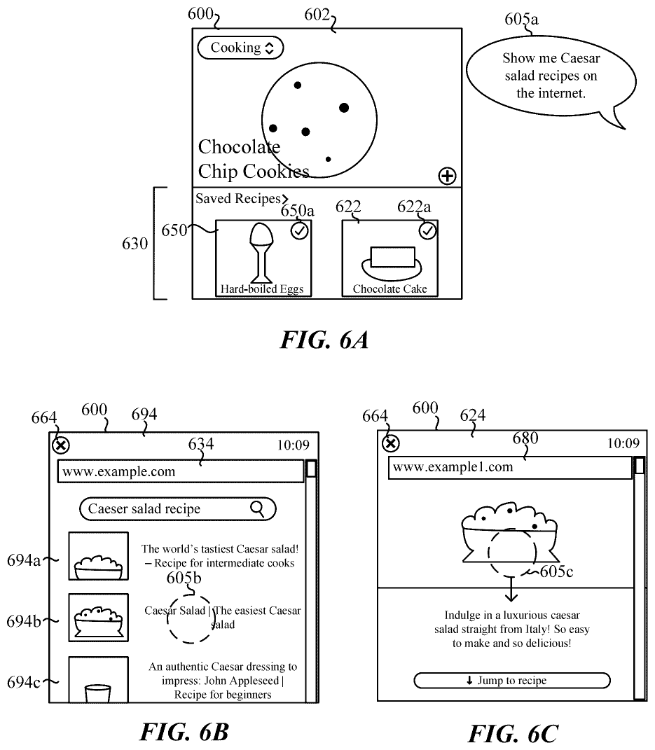

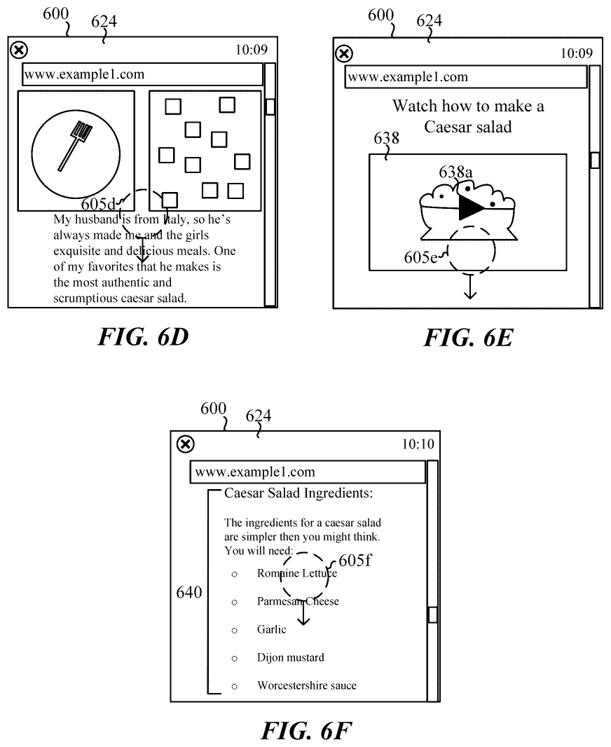

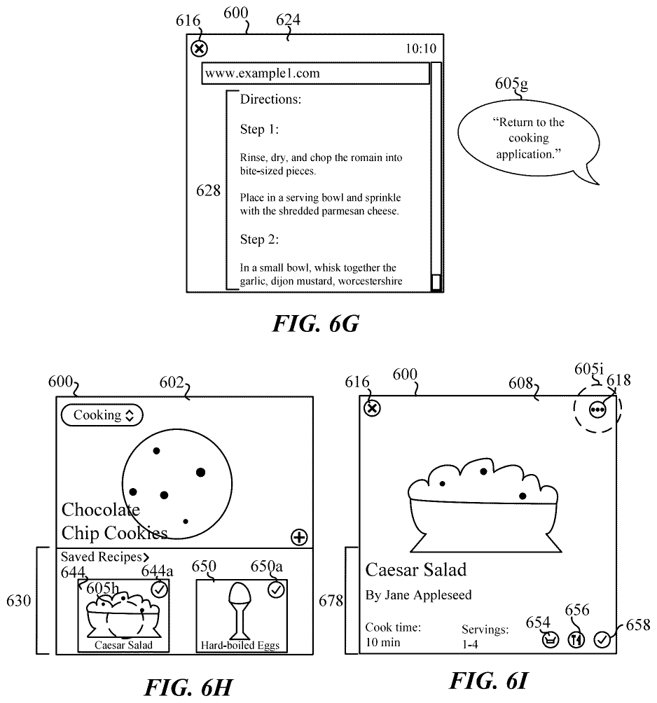

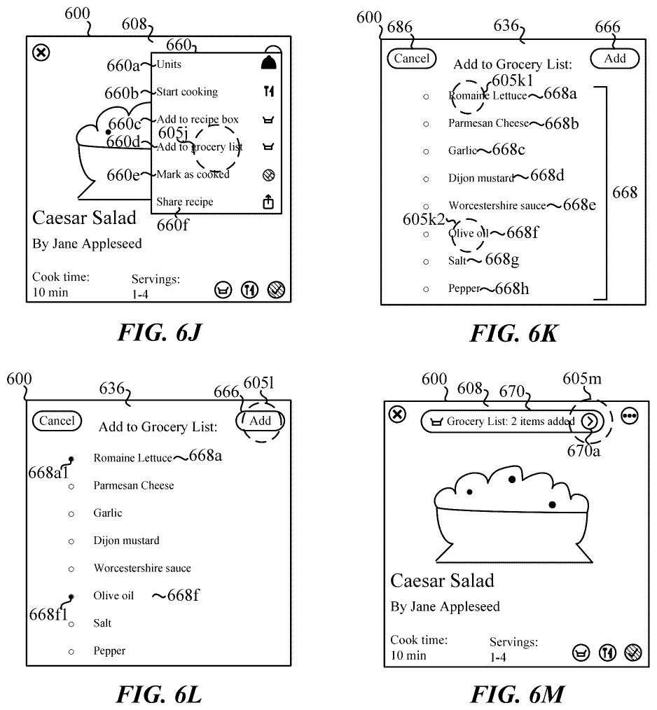

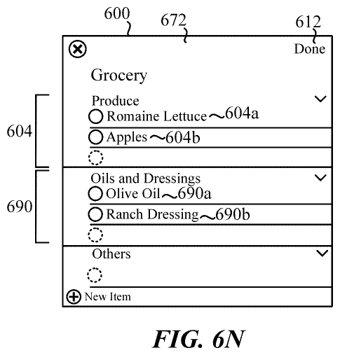

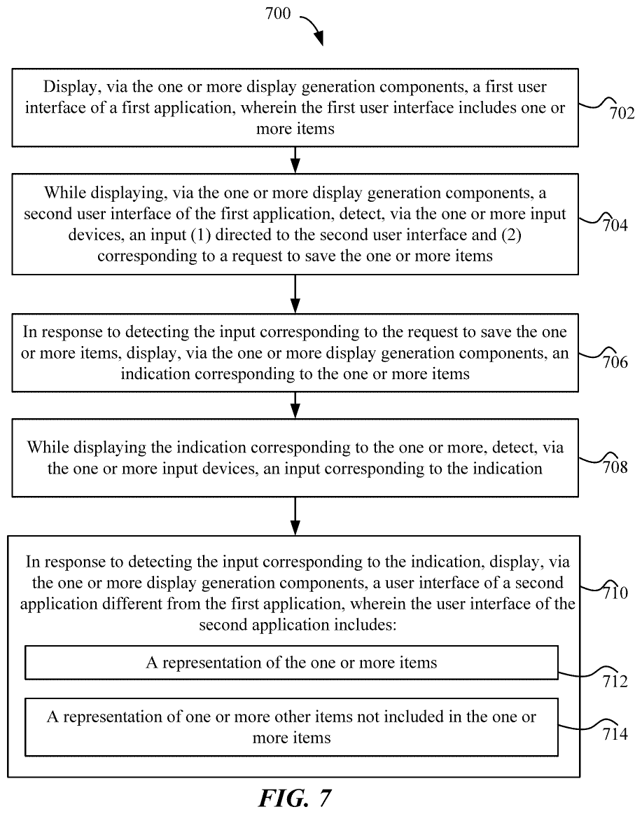

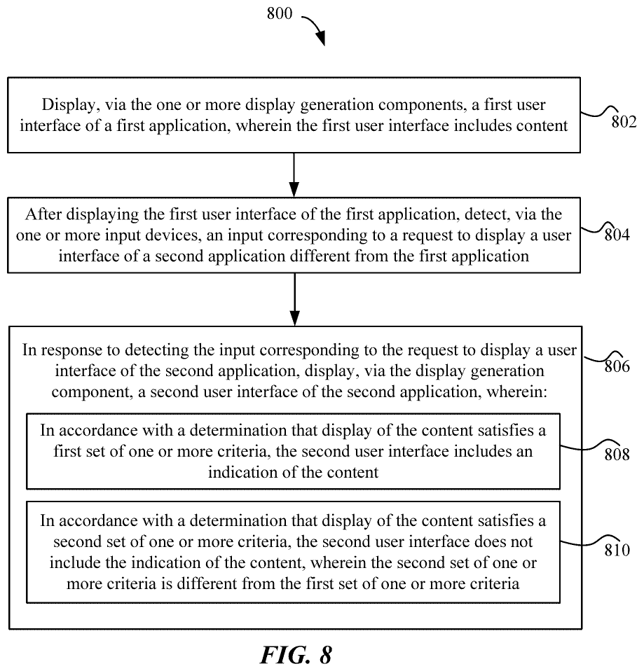

Below, FIGS. 1A-1B, 2, 3A-3G, 4A-4B, and 5A-5B provide a description of exemplary devices for performing the techniques for manipulating web-based content. FIGS. 6A-6N illustrate exemplary user interfaces for interacting with web-based content across multiple applications in accordance with some embodiments. FIG. 7 is a flow diagram illustrating a process for manipulating content from a webpage in accordance with some embodiments. The user interfaces in FIGS. 6A-6N are used to illustrate the processes described below, including the processes in FIG. 7. FIG. 8 is a flow diagram illustrating a process for automatically integrating web-based content into an application in accordance with some embodiments. The user interfaces in FIGS. 6A-6N are used to illustrate the processes described below, including the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, reducing complexities of certain applications, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

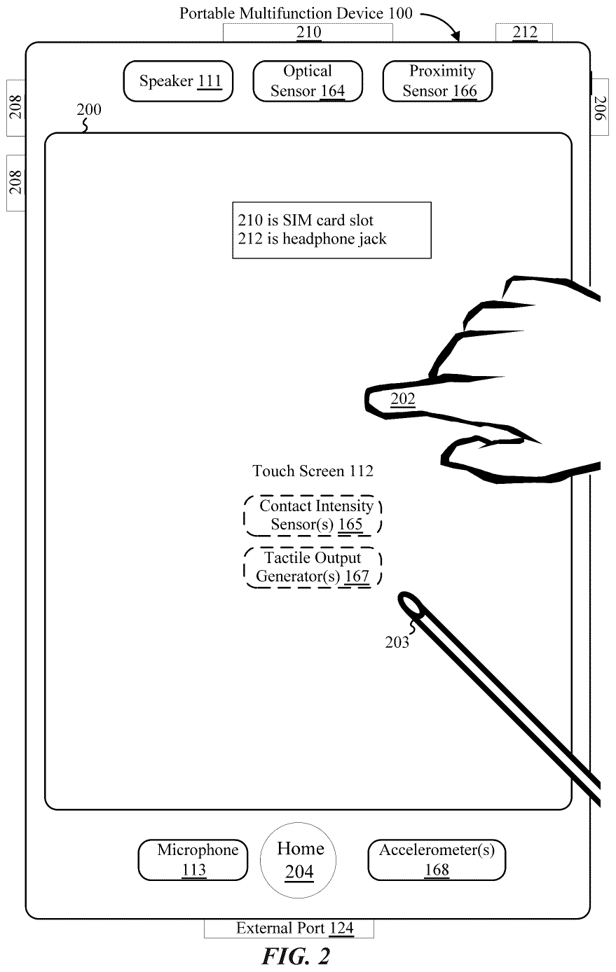

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. Patent Application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

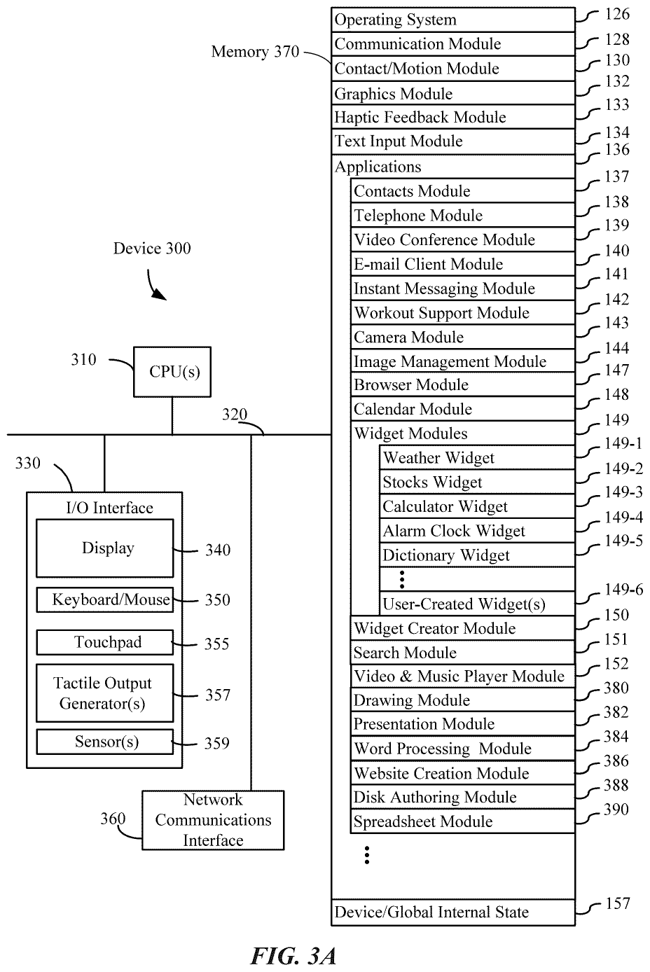

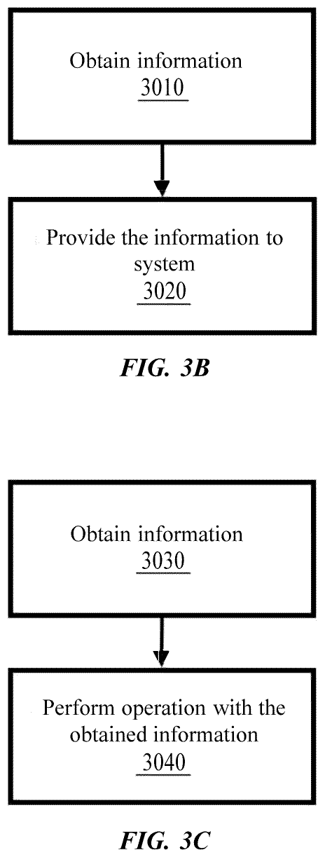

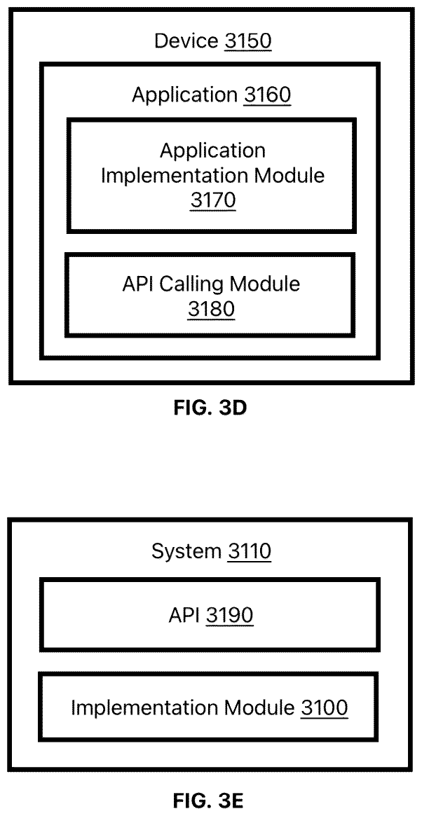

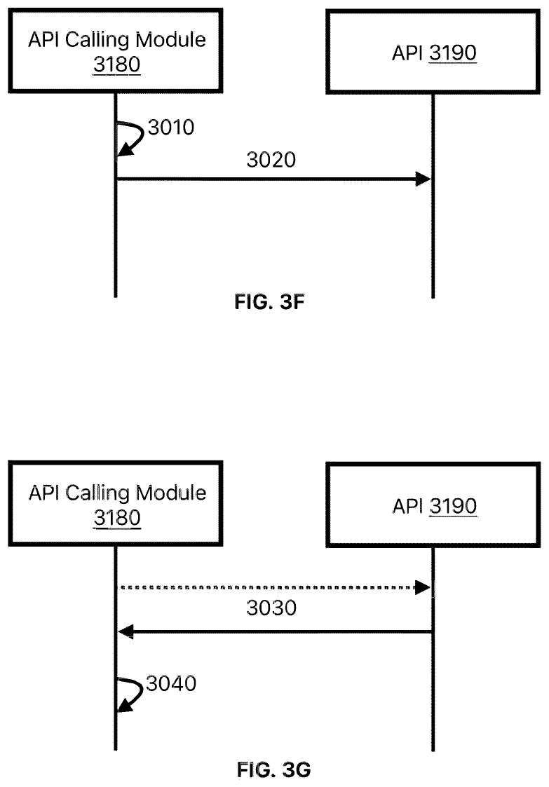

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search Module 151;
Video and music player module 152, which merges video player module and music player module;
Notes module 153;
Map module 154; and/or
Online Video Module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132,

and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562 , “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the process of FIG. 3B, the process of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the process of FIG. 3B and/or the process of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the process of FIG. 3B and/or the process of FIG. 3C by calling an application programming interface (API) (e.g., API 3190) provided by system 3110. In some embodiments, application 3160 performs at least a portion of the process of FIG. 3B and/or the process of FIG. 3C without calling API 3190.

In some embodiments, one or more steps of the process of FIG. 3B and/or the process of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 800 (FIGS. 7 and 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

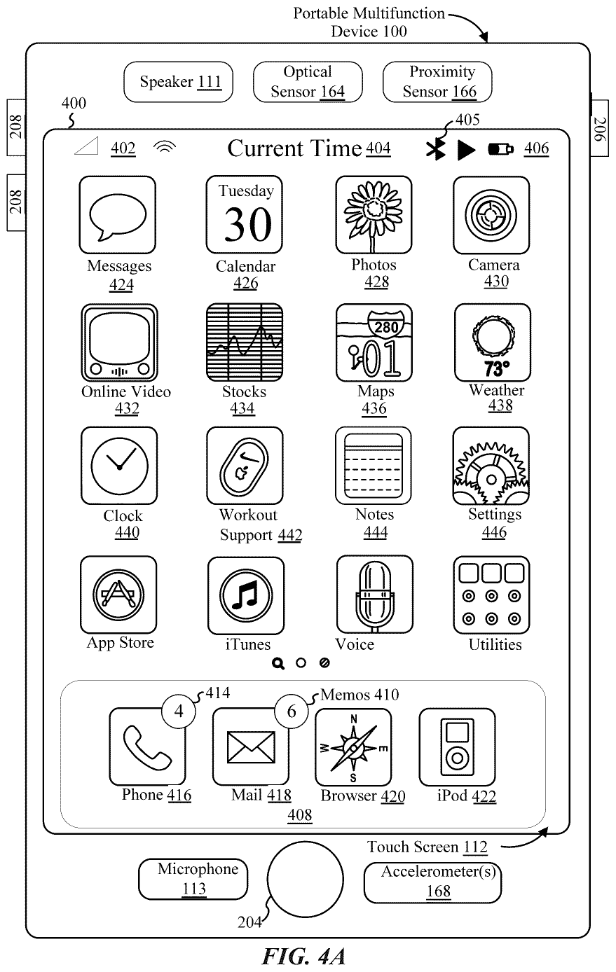

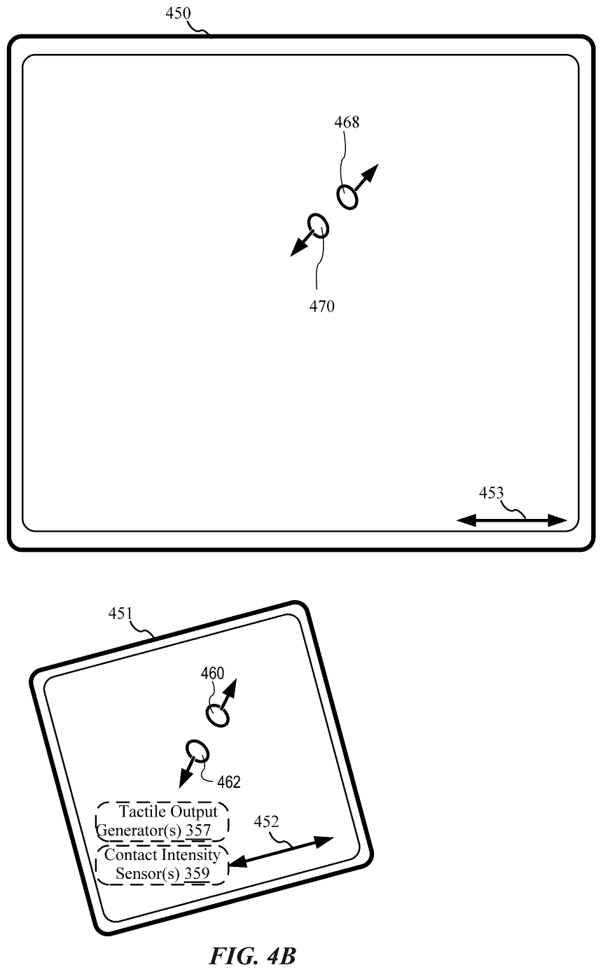

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

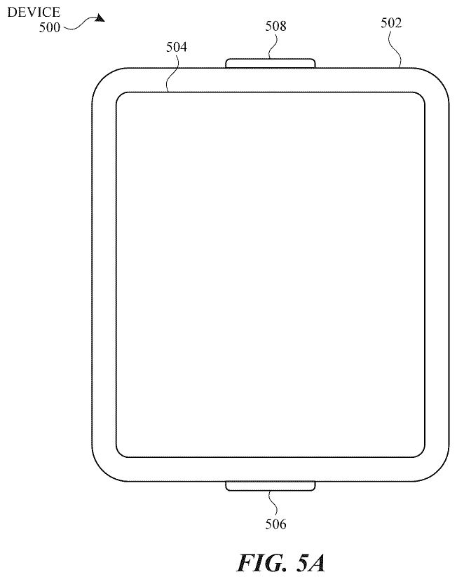

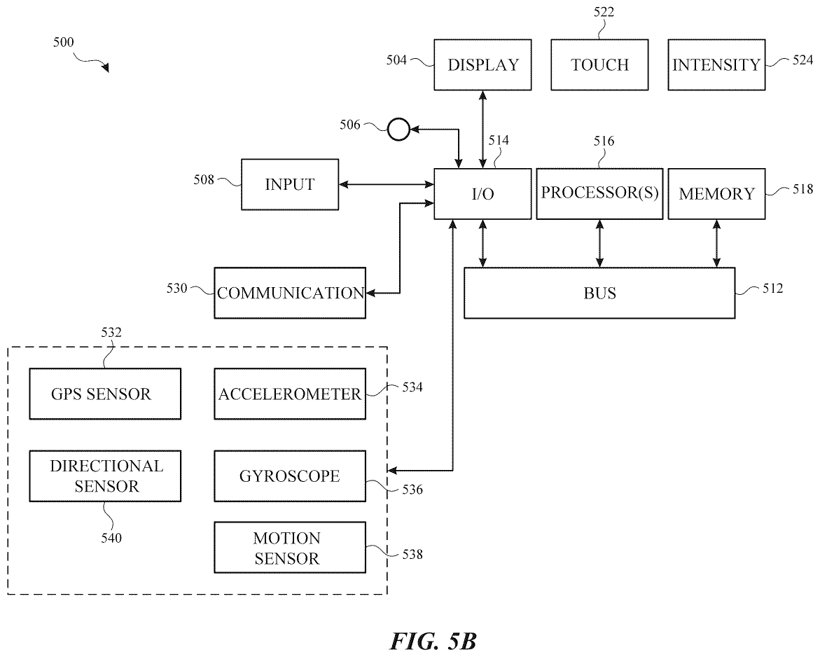

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6N illustrate exemplary user interfaces for interacting with content from web pages in accordance with some embodiments. The user interfaces in these figures are used to illustrate the processes described below, including the processes in FIGS. 7-8.

FIGS. 6A-6N illustrate computer system 600 as a tablet. It should be recognized that computer system 600 can be other types of computer systems such as a smart phone, a smart watch, a laptop, a communal device, an accessory, a personal gaming system, a desktop computer, a fitness tracking device, and/or a head-mounted display (HMD) device. In some embodiments, computer system 600 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 600 includes and/or is in communication with one or more output devices (e.g., a display screen, a projector, a touch-sensitive display, and/or a speaker). In some embodiments, computer system 600 includes one or more components and/or features described above in relation to computer system 100, electronic device 200, and/or electronic device 500.

While the examples in FIGS. 6A-6N include computer system 600 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras.

FIGS. 6A-6H illustrate a process for automatically integrating (e.g., adding, saving, and/or displaying) recipe content from a web page into a cooking application. For example, in response to a determination that a web page includes recipe content (e.g., images, text, videos, directions, ingredients, background, story, details about an author, and/or a conclusion), computer system 600 (and/or another computer system in communication with computer system 600) automatically integrates at least a portion of the recipe content from the web page into the cooking application as further described below.

As illustrated in FIG. 6A, computer system 600 displays user interface 602. In some embodiments, user interface 602 is provided by the cooking application and includes one or more recipes saved to the cooking application within saved recipes region 630. For example, saved recipes region 630 includes hard-boiled egg recipe 650 and chocolate cake recipe 622 (e.g., two saved recipes). In such embodiments, a recipe can be saved to the cooking application manually by a user of computer system 600 and/or automatically in response to a determination that certain criteria are satisfied. For example, in response to a determination that the subject has directed attention towards a web page including recipe content for a certain amount of time (e.g., thirty seconds to fifteen minutes), computer system 600 can automatically save the recipe content into the cooking application. For another example, in response to a determination that a web page including recipe content has been displayed for a certain amount of time (e.g., ten minutes), computer system 600 can automatically save the recipe content into the cooking application. For another example, in response to a determination that the subject has watched a threshold amount (e.g., 10-100%) of a video including receipt content, computer system 600 can automatically save the recipe content into the cooking application. For another example, in response to a determination that the subject has viewed the majority of a web page (e.g., via input, such as a scroll input) including recipe content, computer system 600 can automatically save the recipe content into the cooking application. For another example, in response to a determination that the subject has viewed all of a web page (e.g., via input, such as a scroll input) including recipe content, computer system 600 can automatically save the recipe content into the cooking application. For another example, in response to a determination that the subject is viewing a web page including recipe content that is similar to other recipes that the subject has saved and/or viewed in the past, computer system 600 can automatically save the recipe content into the cooking application. For another example, in response to detecting an input (e.g., a verbal input “This looks good for dinner!”) directed to a web page including recipe content, computer system 600 can automatically save the recipe content into the cooking application. For another example, in response to a determination that a web page includes recipe content that aligns with preferences of the subject, computer system 600 can automatically save the recipe content into the cooking application. For example, if the subject is on a pescatarian diet and in response to a determination that recipe content is in line with a pescatarian diet, computer system 600 automatically saves the recipe content into the cooking application. To the contrary, if the subject is allergic to shellfish, computer system 600 does not automatically save recipe content to the cooking application if the recipe content includes shellfish.

As illustrated in FIG. 6A, hard-boiled egg recipe 650 and chocolate cake recipe 622 include images (e.g., of the completed recipe), as well as the title of the recipe (e.g., “Hard-boiled Eggs” and “Chocolate Cake” respectively). In some embodiments, computer system 600 displays the name of the author of the recipe with hard-boiled egg recipe 650 and/or chocolate cake recipe 622. In some embodiments, computer system 600 displays the name of the web page that the recipe content corresponds and/or is from with hard-boiled egg recipe 650 and/or chocolate cake recipe 622. As also illustrated in FIG. 6A, computer system 600 displays check indicator 650a and check indicator 622a as overlaid on hard-boiled egg recipe 650 and chocolate cake recipe 622 respectively. In some embodiments, computer system 600 displays check indicator 650a and check indicator 622a to indicate that a corresponding recipe has been saved into the cooking application. In such embodiments, recipes without a check indicator would be recipes that have not been saved into the cooking application. It should be recognized that, in some embodiments, recipes saved in different ways (e.g., manually or automatically) can have check indicators with different appearances. In some embodiments, recipes are saved with a date to indicate the date on which the recipe was saved. In some embodiments, recipes are saved with indicators to indicate that a user of computer system 600 has made a recipe and optionally a date(s) on which the recipe was made by the user. In some embodiments, the user is able to save images of the user's own re-creation of a recipe and/or notes (e.g., about the cooking process) along with the recipe.

In some embodiments, hard-boiled egg recipe 650 and chocolate cake recipe 622 correspond to recipes found on the internet that have been added to the cooking application in response to a determination that certain criteria are satisfied (e.g., as discussed above). In some embodiments, the cooking application added hard-boiled egg recipe 650 and/or chocolate cake recipe 622 to the cooking application. In other embodiments, a browser application of computer system 600 integrated hard-boiled egg recipe 650 and/or chocolate cake recipe 622 to the cooking application. In other embodiments, another application (e.g., another application different from the cooking application and the browser application) integrated hard-boiled egg recipe 650 and/or chocolate cake recipe 622 to the cooking application.

In some embodiments, computer system 600 filters recipes within user interface 602. For example, hard-boiled egg recipe 650 and chocolate cake recipe 622 are not the only recipes saved to the cooking application, but rather computer system 600 displays only hard-boiled egg recipe 650 and chocolate cake recipe 622 while other saved recipes are not included within the displayed saved recipes region 630. In some embodiments, computer system 600 filters the recipes based on preference of a subject using computer system 600. For example, if the subject has historically viewed more vegan recipe content, computer system 600 filters recipes within saved recipes region 630 to display more vegan recipes. It should be recognized that user interface 602 is used as an example and that other user interfaces and/or user interfaces from other applications can be used with techniques described herein, such as a note-taking application, an internet browser, a lockscreen, and/or a home screen that is separate from an application including user interface 602. In some embodiments, as discussed above, the displayed saved recipe region 630 can be filtered to a user's preference. In other embodiments, the displayed saved recipe region 630 can include saved recipes that are related to an upcoming event, holiday, or birthday. Although the displayed saved recipe region 630 can include a subset of the saved recipes, a user can be able to access all saved recipes by searching saved recipes or by opening the cooking application.

At FIG. 6A, computer system 600 detects input 605a (e.g., “Show me Caesar salad recipes from the internet”). It should be recognized that input 605a is an example of a verbal input but can be other inputs, such as a typing input on a keyboard and/or a tap input on a virtual keyboard.

As illustrated in FIG. 6B, in response to detecting input 605a, computer system 600 displays user interface 694. In some embodiments, user interface 694 is provided by the browser application and provides search results from the internet as a response to input 605a. As illustrated in FIG. 6B, user interface 694 includes exit control 664, address bar 634 (e.g., “www.example.com”), recipe option 694a (e.g., an intermediate Caesar salad recipe), recipe option 694b (e.g., an easy Caesar salad recipe), and recipe option 694c (e.g., a Caesar salad dressing recipe). In some embodiments, in response to detecting an input directed to exit control 664, computer system 600 ceases display of user interface 694 and displays user interface 602 (e.g., an immediately previously displayed user interface). In some embodiments, in response to detecting an input directed to exit control 664, computer system 600 ceases display of user interface 694 and displays a home screen (e.g., a default user interface displayed when exiting user interface 694) that is separate from the cooking application. In such embodiments, the home screen can be provided by the browser application or an operating system of computer system 600.

It should be recognized that user interface 694 includes multiple search results, each result corresponding to input 605a (e.g., a request for Caesar salad recipes). In some embodiments, each result of the multiple search results (e.g., option 694a-c) falls within a category of Caesar salad recipes but each result is a different option (e.g., intermediate, easy, and dressing). At FIG. 6B, computer system 600 detects input 605b directed to recipe option 694b. It should be recognized that input 605b is an example of a tap input but can be other inputs, such as a verbal input (e.g., “I'd like to make the easy Caesar salad recipe”).

As illustrated in FIG. 6C, in response to detecting input 605b, computer system 600 ceases display of user interface 694 and displays user interface 624. In some embodiments, user interface 694 is provided by the browser application and includes display of a web page corresponding to a Caesar salad recipe. As illustrated in FIG. 6B, user interface 624 includes exit control 664, address bar 680 (e.g., “www.example1.com”), and the web page. The web page includes an image of a Ceaser salad and a brief description (e.g., “Indulge in a luxurious Caesar salad. . . ”) of a recipe. As illustrated in FIG. 6C, computer system 600 updates address bar 680 to reflect the webpage that includes the Caesar salad recipe. It should be recognized that some of the previously mentioned user interface elements (e.g., address bar 680) are separate from the webpage and are provided by the browser application. At FIG. 6C, computer system 600 detects input 605c. It should be recognized that input 605c is an example of a downward swipe input but can be other inputs, such as a verbal input (e.g., ‘Can you scroll down the page?”).

As illustrated in FIG. 6D, in response to detecting input 605c, computer system 600 scrolls down user interface 624. As illustrated in FIG. 6D, as part of scrolling down, computer system 600 ceases display of the previously mentioned content (e.g., the image of the Caesar salad and the brief description) and displays more content corresponding to the Caesar salad recipe, including an image of a plate and a fork, an image of croutons, and a backstory of the author of the Caesar salad recipe. At FIG. 6D, computer system 600 detects input 605d. It should be recognized that input 605d is an example of a downward swipe input but can be other inputs, such as a verbal input (e.g., ‘Can you keep scrolling down the page?”).

As illustrated in FIG. 6E, in response to detecting input 605d, computer system 600 scrolls further down user interface 624. As illustrated in FIG. 6E, as part of scrolling down, computer system 600 ceases display of the previously mentioned content (e.g., the image of a plate and a fork, the image of croutons, and the backstory of the author corresponding to the Caesar salad recipe) and displays more content corresponding to the Caesar salad recipe, including video 638 (e.g., a video of how to prepare the Caesar salad recipe). As illustrated in FIG. 6E, computer system 600 displays play control 638a with video 638. In some embodiments, in response to detecting an input directed to play control 638a, computer system 600 initiates playback of video 638. At FIG. 6E, computer system 600 detects input 605e. It should be recognized that input 605e is an example of a downward swipe input but can be other inputs, such as a verbal input (e.g., ‘Can you keep scrolling down the page?”).

As illustrated in FIG. 6F, in response to detecting input 605e, computer system 600 scrolls further down user interface 624. As illustrated in FIG. 6F, as part of scrolling down, computer system 600 ceases display of the previously mentioned content (e.g., video 638) and displays more content corresponding to the Caesar salad recipe, including ingredients list 640. As illustrated in FIG. 6F, ingredients list 640 includes an introduction to ingredients needed for the Caesar salad recipe as well as a list of the ingredients. At FIG. 6F, computer system 600 detects input 605e. It should be recognized that input 605e is an example of a downward swipe input but can be other inputs, such as a verbal input (e.g., “Can you keep scrolling down the page?”).

As illustrated in FIG. 6G, in response to detecting input 605f, computer system 600 scrolls down user interface 624. As illustrated in FIG. 6G, as part of scrolling down, computer system 600 ceases display of the previously mentioned content (e.g., ingredients list 640) and displays more content corresponding to the Caesar salad recipe, including directions 628. As illustrated in FIG. 6G, directions 628 includes steps required to prepare the Caesar salad recipe. It should be recognized that there are more steps to prepare the Caesar salad recipe than those illustrated in FIG. 6G. At FIG. 6G, computer system 600 detects input 605g (e.g., “Return to the cooking application”). It should be recognized that input 605g is an example of a verbal input but can be other inputs, such as a tap input, an air gesture, and/or a typing input on a keyboard.

As illustrated in FIG. 6H, in response to detecting input 605g, computer system 600 ceases display of user interface 624 and displays user interface 602. At FIG. 6H, in response to a determination that the Caesar salad recipe has satisfied certain criteria (e.g., the subject has scrolled through the entire Caesar salad recipe) as described above, computer system 600 integrates the Caesar salad recipe into the cooking application. As illustrated in FIG. 6H, in response to integrating the Caesar salad recipe content into the cooking application, computer system 600 displays Caesar Salad recipe 644 within saved recipes region 630. As also illustrated in FIG. 6H, computer system 600 displays check indicator 644a as overlaid on Caesar Salad recipe 644. In some embodiments, computer system 600 displays check indicator 644a to indicate that Caesar Salad recipe 644 corresponds to recipe content from a web page that has been integrated into the cooking application. At FIG. 6H, computer system 600 detects input 605h directed to Caesar Salad recipe 644. It should be recognized that input 605h is an example of a tap input but can be other inputs, such as verbal input, an air gesture, and/or a mouse click.

FIGS. 6I-6N illustrate a process for adding ingredients from a recipe to a grocery list. As illustrated in FIG. 6I, in response to detecting input 605h, computer system 600 ceases display of user interface 602 and displays user interface 608. As illustrated in FIG. 6I, computer system 600 displays content included in user interface 608 to act as a landing page, creating a clear starting point for the Caesar salad recipe in the cooking application. As will be discussed below (e.g., with respect to FIG. 6K), computer system 600 separates directions, ingredients, and/or other recipe content into different distinct portions in order to better guide a subject in preparing the recipe.

In some embodiments, user interface 608 is provided by the cooking application and includes content from the Caesar salad recipe sourced from a webpage. For example, at FIG. 6I, user interface 608 (e.g., including content of information region 678 as well as the image of the Caesar salad) can be extracted and/or derived from recipe content found in a web page (e.g., the web page included in user interface 624). For another example, a set of ingredients for the Caesar salad recipe can be sourced from a webpage (e.g., as illustrated in FIG. 6F as scrollable text) and presented in an interactable format within the cooking application (e.g., as illustrated in FIGS. 6K-6L as a selectable list). Such content from a webpage can be directly from, generated based on, or a modified version of content from the web page. As illustrated by the image of the Caesar Salad in user interface 608 is larger than the image of the Caesar Salad in user interface 624 (e.g., in FIG. 6C), illustrating that the manner of presentation of some content can be changed when displaying within the cooking application to allow for a better interactive experience. Additionally, certain inferences about the recipe content can be made without direct sources within the recipe content. For example, the cook time of 10 minutes can be determined based on time required for individual steps of the Caesar salad recipe without the web page for the Caesar salad recipe including the cook time of 10 minutes.

As illustrated in FIG. 6I, user interface 608 includes options control 618, grocery list control 654, selection control 658, start cooking control 656, the image of the Caesar Salad, and information region 678 including information corresponding to the Caesar salad recipe. As illustrated in FIG. 6I, information region 768 includes the title of the recipe, the author's name, the cook time, and the number of servings the recipe will yield (e.g., all content derived from the web page corresponding to user interface 624). In some embodiments, in response to detecting an input directed to options control 618, computer system 600 displays a menu that includes a list of controls that allows a subject to interact with a recipe, as will be discussed later. In some embodiments, in response to detecting an input directed to grocery list control 654, computer system 600 displays user interface 636 (e.g., which includes a list of ingredients for adding ingredients to a grocery list), as discussed further in FIG. 6K. In some embodiments, in response to detecting an input directed to selection control 658, computer system 600 removes the Caesar salad recipe from the saved recipes (e.g., the Caesar salad recipe will no longer be included within saved recipes region 630).

In some embodiments, in response to detecting an input directed to start cooking control 656, computer system 600 ceases display of user interface 608 and displays cooking user interface that guides the subject on how to prepare the recipe. In some embodiments, the cooking user interface presents portions of the Caesar salad recipe serially to provide an easier-to-follow presentation while preparing the Caesar salad recipe. For example, computer system 600 displays each step of the Caesar salad recipe individually rather than in a list of steps (e.g., as illustrated in FIG. 6G). Additionally, in some embodiments, computer system 600 transitions between portions of content to provide a guided experience for preparing the Caesar salad recipe. For example, displaying a step of the Caesar salad recipe for a required amount of time to finish the step, and transitions to additional steps as a subject completes those steps. In some embodiments, computer system 600 provides additional modalities for guiding a subject through a recipe. For example, computer system 600 audibly outputs each step of the Caesar salad recipe along with displaying each step of the recipe in response to detecting the input to start cooking control 656. While such examples are provided to illustrate that computer system 600 can present recipe content in an alternative presentation to make the recipe content easier-to-follow, it should be recognized that additional functionality can be provided by the cooking application and/or the cooking user interface to further a subject's ability to prepare the recipe content At FIG. 6I, computer system 600 detects input 605i directed to options control 618. It should be recognized that input 605i is an example of a tap input but can be other inputs, such as verbal input, an air gesture, and/or a mouse click.

As illustrated in FIG. 6J, in response to detecting input 605i, computer system 600 displays overlay 660. Overlay 660 includes units control 660a, start cooking control 660b, saved recipes control 660c, grocery list control 660d, mark control 660e, and share recipe control 660f. In some embodiments, in response to detecting an input directed to units control 660a, computer system 600 alters the units of the Caesar salad recipe. For example, in response to detecting an input directed to units control 660a, computer system 600 displays metric and/or imperial measurement options to allow a subject to select their preference for units that are used. In some embodiments, in response to detecting an input directed to start cooking control 660b, computer system 600 ceases display of user interface 608 and displays a user interface that guides the subject on how to prepare the recipe (e.g., as described above with respect to start cooking control 656). In some embodiments, in response to detecting an input directed to saved recipes control 660c, computer system 600 adds the Caesar salad recipe to the saved recipes of the cooking application if the Caesar salad recipe is not already in the saved recipes. In some embodiments, computer system 600 removes the Caesar salad recipe from the saved recipes of the cooking application in response to detecting an input directed to saved recipes control 660c. For example, computer system 600 no longer including the Caesar salad recipe in saved recipe region 630 in response to detecting an input directed to saved recipes 660c.

In some embodiments, in response to detecting an input directed to grocery list control 660d, computer system 600 ceases display of user interface 608 and displays a user interface that includes all the ingredients of the recipe (e.g., as illustrated in FIG. 6K), allowing a subject to select ingredients to be added to a grocery list (e.g., a grocery list that corresponds to a separate application from the internet browser and/or the cooking application). In some embodiments, in response to detecting an input directed to mark control 660e, computer system 600 marks the Caesar salad recipe as cooked in the cooking application (e.g., shaded in selection control 658 at FIGS. 6J & 6M) to allow a subject to keep track of what recipes they have already cooked. For example, while displaying user interface 602, computer system 600 alters the presentation of Caesar salad recipe 644 in saved recipes region 630 by (1) shading Caesar salad recipe 644, (2) shading in an icon (e.g., shading check indicator 644a at FIG. 6H similarly to selection control 658 at FIG. 6J), and/or (3) including another icon to show it has already been prepared. In some embodiments, in response to detecting an input directed to share recipe control 660f, computer system 600 initiates a process to share the Caesar salad recipe with another computer system. For example, computer system 600 can initiate a proximity-based sharing process (e.g., Bluetooth and/or Near Field Communication) and/or network-based sharing process (e.g., Email and/or Messenger) in response to detecting the input directed to share recipe control 660f. At FIG. 6J, computer system 600 detects input 605j directed to grocery list control 660d. It should be recognized that input 605i is an example of a tap input but can be other inputs, such as verbal input, an air gesture, and/or a mouse click. In some embodiments, computer system 600 can initiate sharing of a recipe as well as sharing of any notes or images about the recipe that a user of the computer system 600 has saved. In some embodiments, the user has the option to share only the recipe and/or the recipe and other artifacts (e.g., notes and/or images) that the user has saved related to the recipe. In some embodiments, the user can also be able to save and share other media content (e.g., voice memos or videos) related to the recipe. For example, the recipe can include an instructional video explaining that a user should “fold in the cheese” in a recipe. In some embodiments, the media content related to the recipe can be external to the recipe. For example, a less experienced cook user may search the internet for a video on how to fold in cheese and save that video along with the recipe to refer back to how to accomplish the step. For another example, a more experienced cook user may take a short video clip of themselves folding in cheese for the recipe and save it along with the recipe so that it can be shared with friends or family.

As illustrated in FIG. 6K, in response to detecting input 605j, computer system 600 ceases display of user interface 608 and displays user interface 636. In some embodiments, user interface 636 is provided by the cooking application and includes a list of ingredients for the Caesar salad recipe. As illustrated in FIG. 6K, user interface 636 includes cancel control 686, add control 666, and ingredients list 668. In some embodiments, in response to detecting an input directed to cancel control 686, computer system 600 ceases display of user interface 636 and displays user interface 608. In some embodiments, in response to detecting an input directed to cancel control 686 when ingredients are selected, computer system 600 deselects the selected ingredients and maintains display of user interface 636. In some embodiments, in response to detecting an input directed to add control 666, computer system 600 adds any selected ingredients to a grocery list as described further below with respect to FIG. 6K. Additionally, in response to detecting an input directed to add control 666, computer system 600 ceases display of user interface 636 and displays user interface 608.

As illustrated in FIG. 6K, ingredients list 668 includes a series of ingredients corresponding to the Caesar salad recipe, including romaine lettuce indicator 668a, parmesan cheese indicator 668b, garlic indicator 668c, Dijon mustard indicator 668d, Worcestershire sauce indicator 668e, olive oil indicator 668f, salt indicator 668g, and pepper indicator 668h. As illustrated in FIG. 6K, computer system 600 displays ingredients list 668 in user interface 624 in a different format than ingredients list 640 in user interface 636. For example, computer system 600 displays ingredients list 668 as a list without including any introduction (e.g., as illustrated in FIG. 6F). Additionally, user interface 636 includes ingredient indicators within ingredients list 668 to provide the ability to add ingredients to a grocery list, a feature not included with user interface 624 (e.g., the non-selectable list of ingredients within the webpage of FIG. 6F). It should be recognized that other changes can occur, such as changing font and/or font size as well as converting from comma-delimited list to a bulleted list.

In some embodiments, in response to detecting an input directed to an ingredient indicator within ingredients list 668, computer system 600 selects the ingredient (as will be discussed with respect to FIG. 6L). For example, in response to detecting an input directed to romaine lettuce indicator 668a, computer system 600 selects romaine lettuce indicator 668a to be added to a grocery list. It should be recognized that each ingredient indicator has a corresponding selection indicator. In some embodiments, in response to selecting an ingredient to add to a grocery list, computer system 600 displays a selection indicator as colored in to indicate that the corresponding ingredient indicator has been selected. In some embodiments, as part of displaying user interface 636, computer system 600 automatically selects all ingredient indicators. In some embodiments, ingredients list 668 includes a quantity of one or more ingredients. In such embodiments, when selecting an ingredient to be added to the grocery list, computer system 600 can provide a process for selecting an amount of the ingredient through user interface 636.

It should be recognized that, in some embodiments, computer system 600 includes content included in user interface 636 (e.g., ingredient list 668 and add control 666) within user interface 608 (e.g., as a part of user interface 608, such as located beneath content included in user interface 608 as illustrated in FIG. 6I). In such embodiments, in response to detecting input (e.g., a downward swipe) while displaying user interface 608, computer system 600 can display ingredient list 668 and add control 666). At FIG. 6K, computer system 600 detects input 605k1 directed to romaine lettuce indicator 668a. Additionally, computer system 600 detects input 60k2 directed to olive oil indicator 668f. It should be recognized that inputs 605k1 and 605k2 are examples of tap inputs but can be other inputs, such as verbal inputs, air gestures, and/or mouse clicks.

At FIG. 6L, after detecting inputs 605k1 and 605k2, computer system 600 selects romaine lettuce indicator 668a and olive oil indicator 668f. As illustrated in FIG. 6L, in response to selecting romaine lettuce indicator 668a and olive oil indicator 668f, computer system 600 displays selection indicators 668a1 and 668f1 as colored in. At FIG. 6L, computer system 600 detects input 605l directed to add control 666. It should be recognized that input 605l is an example of a tap input but can be other inputs, such as a verbal input, an air gesture, and/or a mouse click. In some embodiments, in response to detecting input 605l, computer system 600 adds the ingredients corresponding to the selected ingredient indicators (e.g., romaine lettuce indicator 668a and olive oil indicator 668f) to a grocery list.

In some embodiments, the grocery list is provided by and/or hosted by another application (e.g., a list application). For example, the cooking application sends the selected ingredients (e.g., romaine lettuce and olive oil as illustrated in FIG. 6L) to the other application to be added to the grocery list. In some embodiments, the grocery list is a list provided by a system application. For example, computer system 600 directly interacts with lists (e.g., storage locations) of the system application to add the selected ingredients. In some embodiments, cooking application adds the ingredients corresponding to the selected ingredient indicators (e.g., romaine lettuce indicator 668a and olive oil indicator 668f) to the grocery list. For example, computer system 600 can modify, add to, and/or remove items of an existing grocery list (e.g., provided by a list application). In some embodiments, the application that corresponds to the grocery list adds the ingredients corresponding to the selected ingredient indicators (e.g., romaine lettuce indicator 668a and olive oil indicator 668f) to the grocery list. In some embodiments, in a scenario where the grocery list did not exist yet, in response to detecting input 605l, computer system 600 creates a grocery list to add the ingredients corresponding to the selected ingredient indicators (e.g., romaine lettuce indicator 668a and olive oil indicator 668f).

In some embodiments, in response to detecting an input directed to add control 666 (e.g., input 605l), computer system 600 continues display of user interface 636. In such embodiments, computer system 600 displays grocery list notification 670 at the top of user interface 636. In some embodiments, in response to detecting an input directed to add control 666, computer system 600 ceases display of user interface 636 and displays user interface 602. In such embodiments, computer system 600 displays grocery list notification 670 at the top of user interface 602.

As illustrated in FIG. 6M, in response to detecting input 605l, computer system 600 ceases display of user interface 636 and displays user interface 608. As well, as illustrated in FIG. 6M, after adding the selected ingredients to the grocery list, computer system 600 displays grocery list notification 670. In some embodiments, computer system 600 simultaneously displays user interface 608 and grocery list notification 670 in response to either (1) already adding the selected ingredient to the grocery list and/or (2) computer system 600 waiting to display user interface 608 until the selected ingredients are added to the grocery list. In some embodiments, grocery list notification 670 is displayed on top of or outside of user interface 608. In such embodiments, notification 670 can be separate from user interface 608 and/or maintained as a subject navigates to other user interfaces until notification 670 is manually dismissed or automatically dismissed over time when a subject has not interacted with notification 670. In other embodiments, navigation to another user interface causes notification 670 to be dismissed.

As illustrated in FIG. 6M, grocery list notification 670 includes an indication of ingredients added to the grocery list (e.g., “Grocery List: 2 items added”) and caret 670a. In some embodiments, in response to detecting an input directed to caret 670a, computer system 600 ceases display of user interface 608 and displays a grocery list user interface corresponding to another application (e.g., the list application discussed above in FIG. 6L and/or the list application as discussed below in FIG. 6N) separate from the cooking application. In some embodiments, computer system 600 displays grocery list notification 670 with a title of the application that corresponds to the grocery list, such as a title defined by the other application or defined by a subject when creating the grocery list. In some embodiments, grocery list notification 670 is a notification that is generated and/or created by an operating system of computer system 600 and includes content from the other application (e.g., the list application as discussed below at FIG. 6N). For example, computer system 600 displaying grocery list notification 670 due to the other application alerting the operating system that a new list with the selected ingredients was successfully created and/or that the selected ingredients were successfully added to an existing grocery list (e.g., as briefly discussed above). At FIG. 6M, computer system 600 detects input 605m directed to caret 670a. It should be recognized that input 605m is an example of a tap input but can be other inputs, such as a verbal input, an air gesture, and/or a mouse click.

As illustrated in FIG. 6N, in response to detecting input 605m, computer system 600 ceases display of user interface 608 and displays user interface 672. In some embodiments, user interface 672 is provided by the list application. As illustrated in FIG. 6N, user interface 672 includes done control 612, produce region 604 with romaine lettuce indicator 604a and apples indicator 604b, and oils and dressings region 690 with olive oil indicator 690a and ranch dressing indicator 690b. It should be recognized that romaine lettuce indicator 604a corresponds to romaine lettuce indicator 668a and is included within user interface 672 in response to input 605l. It should be recognized that olive oil indicator 690a corresponds to olive oil indicator 668f and is included within user interface 672 in response to input 605l. It should also be recognized that apples indicator 604b and ranch dressing indicator 690b existed within user interface 672 before romaine lettuce indicator 604a and olive oil indicator 690a were added and do not correspond to the Caesar salad recipe. In some embodiments, apples indicator 604b and ranch dressing indicator 690b were added to user interface 672 through as similar process as described herein. For example, adding apples and ranch dressing to user interface 672 in response to detecting an input selecting apples and ranch dressing from an “add to grocery list” user interface (e.g., an alternative version of user interface 636 of FIG. 6K containing different ingredients) of another recipe (e.g., another saved recipe from the cooking application). Alternately, in some embodiments, apples indicator 604b and ranch dressing indicator 690b can be manually added to user interface 672. For example, apples and ranch dressing were entered via one or more input methods on computer system 600 and/or via another device (e.g., a linked device adding ingredients to a shared grocery list).

In some embodiments, in response to an input directed to an ingredient indicator, computer system 600 ceases display of the ingredient indicator from user interface 672. For example, in response to detecting an input directed to olive oil indicator 690a, computer system 600 removes olive oil indicator 690a from the grocery list (e.g., similar to checking an ingredient off a list, to help a subject know that they have acquired the ingredient), a feature not provided by user interface 636 (e.g., through the cooking application).

As illustrated in FIG. 6N, ingredients included in user interface 672 are a different format than in user interface 636 and/or user interface 624. For example, ingredients in user interface 672 have been separated into different categories that correspond to different types of ingredients, such as romaine lettuce indicator 604a and apples indicator 604b are within produce region 604 because romaine lettuce and apples are categorized as produce.

FIG. 7 is a flow diagram illustrating a process (e.g., process 700) for manipulating content from a webpage in accordance with some embodiments. Some operations in process 700 are, optionally, combined, the orders of some operations are, optionally, changed, and some operations are, optionally, omitted.

As described below, process 700 provides an intuitive way for manipulating content from a webpage. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication with one or more input devices (e.g., as discussed above with respect to FIG. 6A) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) and one or more display generation components (e.g., as discussed above with respect to FIG. 6A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system displays (702), via the one or more display generation components, a first user interface (e.g., 624 at FIGS. 6C-6G) (e.g., a recipe user interface, an ingredient user interface, a cooking user interface, an application user interface, a portion of a user interface, and/or web based content within an application user interface) of a first application (e.g., as discussed above with respect to FIG. 6A) (e.g., cooking application, news application, recipe application, browser application, system application, third-party application, first application containing grouped content, and/or application containing food, recipe, and/or cooking content), wherein the first user interface includes one or more items (e.g., ingredients within 624 at FIG. 6F) (e.g., a first item and/or a second item separate from the first item). In some embodiments, the one or more items correspond to a recipe. In some embodiments, the one or more items are ingredients for the recipe. In some embodiments, the one or more items are included in a list. In some embodiments, the one or more items are not included in a list and/or other type of grouping. In some embodiments, the one or more items are of a same and/or similar category. In some embodiments, the one or more items share one or more characteristics (e.g., components of a common recipe, ingredient, step, and/or food content). In some embodiments, the one or more items are within a common genre (e.g., list of recipes, recipe recommendations, and/or food related content). In some embodiments, the computer system and/or the first application obtains the one or more items from a webpage (e.g., cooking blog, food channel article, and/or travel blog) and/or third-party application (e.g., social media application and/or food entertainment application). In some embodiments, each item in the one or more items is a content item.

While displaying, via the one or more display generation components, a second user interface (e.g., 636 at FIG. 6K-6L) (e.g., the first user interface or another user interface different from the first user interface) of the first application, the computer system detects (704), via the one or more input devices, an input (e.g., a tap input and/or a voice request) (e.g., 605k1, 605k2, and/or 6058i) (1) directed to the second user interface and (2) corresponding to a request to save the one or more items (e.g., to a list, a data structure, and/or a file). In some embodiments, the input corresponding to the request to save the one or more items includes a tap input on an “add” button for adding the one or more items to a list, such as a grocery list.

In response to detecting the input corresponding to the request to save the one or more items (and/or while displaying the first user interface of the first application, the second user interface of the first application, and/or the other user interface of the first application), the computer system displays (706), via the one or more display generation components, an indication (and/or user interface element) (e.g., 670 at FIG. 6M) corresponding to the one or more items. In some embodiments, the indication includes an identification of a number of items included in the one or more items. In some embodiments, the indication includes an identification of an item in the one or more items. In some embodiments, the indication is displayed on top of the first user interface of the first application, the second user interface of the first application, and/or the other user interface of the first application.

While displaying the indication corresponding to the one or more items (and/or while displaying the first user interface of the first application, the second user interface of the first application, and/or the other user interface of the first application), the computer system detects (708), via the one or more input devices, an input (e.g., a tap input and/or a voice request) (e.g., 605m at FIG. 6M) corresponding to (e.g., directed to, at a location of, related to, and/or associated with) the indication. In some embodiments, the input corresponding to the indication is directed to a control included in the indication. In some embodiments, the input corresponding to the indication is a tap input on the indication.

In response to detecting the input corresponding to the indication, the computer system displays (710), via the one or more display generation components, a user interface (e.g., an application user interface, a portion of a user interface, and/or web-based content within an application user interface) (e.g., 672 at FIG. 6N) of a second application (e.g., as discussed above with respect to FIG. 6N) (e.g., a notes application, a list application, a word-processing application, a browser application, a system application, and/or a third-party application) different from the first application, wherein the user interface of the second application includes: (712) a representation (e.g., 604a and/or 690a) of the one or more items (e.g., a representation of the first item and a representation of the second item separate from the representation of the second item and/or a single representation of the one or more items); and a (714) representation (e.g., 604b and/or 690b) of one or more other items not included in the one or more items. In some embodiments, in response to detecting the input corresponding to the indication, the computer system ceases display of the first user interface of a user interface of the first application, such as the first user interface of the first application and/or the second user interface of the first application. In some embodiments, in response to detecting the input corresponding to the indication, the computer system ceases display of the indication. In some embodiments, the first application and the second application are different types of applications. In some embodiments, the first application and the second application include one or more different user interfaces. In some embodiments, the indication is a system indication (e.g., a notification that is not created by an application, including the first application and the second application). In some embodiments, the indication is from and/or corresponds to the second application. In some embodiments, the indication is from and/or corresponds to the first application. In some embodiments, the indication is displayed outside of a user interface of the first application (e.g., the indication is displayed on a portion of a screen without a user interface of the first application or over top of a user interface the first application). In some embodiments, the indication corresponds to and/or is associated with the first application and/or the second application. In some embodiments, the indication includes an indication of a progress for saving the one or more items. In some embodiments, the indication includes a control (e.g., a user interface object corresponding to the second application). Displaying a user interface of one application with items saved using a user interface of another application allows the computer system to integrate functionality of different applications so that each application is not required to implement every feature, thereby reducing complexities of certain applications, providing improved visual feedback to a user, and/or performing an operation when a set of conditions has been met without requiring further user input. Displaying items saved from one application within a list of items in another application in response to an input on an indication displayed in response to saving the items using the one application allows the computer system to transition to a user interface of the other application when interacting with the one application, thereby providing improved visual feedback to a user and/or performing an operation when a set of conditions has been met without requiring further user input.

In some embodiments, the first user interface corresponds to (e.g., relates to, has information for, contains, and/or includes) a recipe (e.g., 624). In some embodiments, the recipe includes ingredients, steps, and/or information for preparing the recipe. In some embodiments, the one or more items are one or more ingredients (e.g., 640 at FIG. 6F) of the recipe. In some embodiments, an amount of an ingredient of the one or more ingredients of the recipe within the first user interface is a total of the ingredient used within all steps of the recipe. In some embodiments, the input corresponding to the request to save the one or more items is a request (e.g., 605l) to add the one or more ingredients of the recipe to a grocery list (and/or the second application). In some embodiments, the second application is a system application for managing lists. In some embodiments, the computer system creates a new grocery list for the one or more ingredients of the recipe. In some embodiments, the computer system adds the one or more ingredients to an existing grocery list. In some embodiments, the grocery list is managed, is provided by, corresponds to, and/or is associated with the second application (e.g., the grocery lists is a list from a set of one or more lists managed by the second application).

In some embodiments, the first application is a content application (e.g., as discussed above with respect to FIG. 6A) (e.g., an application that obtains content from web-based, server-based, and/or other application-based content and/or an application that includes content from one or more sources). In some embodiments, the second application is a list application (e.g., as discussed above with respect to FIG. 6N) (e.g., an application that contains information that is stored in one or more formatted schemes and/or an application for tracking one or more items). In some embodiments, a list application is a different type of application than a content application such that the list application and/or the content application contain one or more functionalities not found in the other application (e.g., to access content from third-party sources, to store content and/or items, and/or to format in one or more ways). Displaying a representation of one or more items within a list application in response to detecting an input to save the one or more items within a content application allows the computer system to transition between different types of applications and use applications specialized for certain features when such features are required, thereby providing improved visual feedback to a user and/or performing an operation when a set of conditions has been met without requiring further user input.

In some embodiments, while (and/or after) displaying the indication corresponding to the one or more items, the computer system detects a threshold amount of time (e.g., as discussed above with respect to FIG. 6M) (e.g., an predetermined amount of time and/or time value set by the computer system and/or the user) has passed without detecting, via the one or more input devices, an input (e.g., a tap input and/or voice request) corresponding to (e.g., directed to, at a location of, related to, and/or associated with) the indication corresponding to the one or more items (e.g., since displaying the indication corresponding to the one or more items and/or since detecting the request to save the one or more items). In some embodiments, in response to detecting the threshold amount of time has passed, the computer system ceases display of, via the one or more display generation components, the indication corresponding to the one or more items. Ceasing display of an indication corresponding to one or more saved items in response to detecting that an amount of time has passed since saving the one or more saved items allows the computer system to temporarily provide a visual cue of status without cluttering a user interface by removing the visual cue once the visual cue is no longer needed, thereby providing improved visual feedback to a user and/or performing an operation when a set of conditions has been met without requiring further user input.

In some embodiments, the indication corresponding to the one or more items corresponds to (e.g., managed by, provided by, relates to, and/or is associated with) an operating system (e.g., as discussed above with respect to FIG. 6M) (e.g., an operating system of the computer system). In some embodiments, the indication corresponding to the one or more items includes content from the second application (and/or obtained from the second application by the operating system). In some embodiments, the content from the second application includes information about the one or more items and/or the one or more other items. In some embodiments, the content from the second application includes content about the second application such as application name, number of items in the second application, and/or status of the second application. Displaying an indication, provided by an operating system, of one or more saved items allows the computer system to provide a visual cue of content saved to an application irrespective of which application the content is saved from, thereby providing improved visual feedback to a user and/or performing an operation when a set of conditions has been met without requiring further user input.

In some embodiments, the indication corresponding to the one or more items is concurrently displayed with (e.g., on top of, overlaid on, alongside, separate from, and/or at the same time as) a third user interface (e.g., 608 at FIG. 6M) of the first application. In some embodiments, the third user interface is the first user interface of the first application or the second user interface of the first application. Displaying an indication of one or more items saved from an application along within a user interface of the application, the indication used to access another application from which the one or more items are saved, allows the computer system to maintain user interfaces of the application while enabling access to user interfaces of the other application, thereby reducing the number of inputs needed to perform an operation and/or performing an operation when a set of conditions has been met without requiring further user input.

In some embodiments, the indication corresponding to the one or more items is displayed on top of (e.g., over and/or in front of) the third user interface (e.g., 608 at FIG. 6M) of the first application. In some embodiments, displaying the indication corresponding to the one or more items on top of the third user interface of the first application includes partially occluding a portion of the third user interface of the first application. Displaying an indication of one or more items saved in one application on top of a user interface of another application allows the computer system to continue display content of the other application while providing a visual confirmation that the one or more items are saved, thereby providing improved visual feedback to a user and/or performing an operation when a set of conditions has been met without requiring further user input.

In some embodiments, the third user interface (e.g., 608) of the first application is the second user interface of the first application.

In some embodiments, the one or more items (e.g., 668) includes a first item (e.g., one of 668a-668h) (e.g., a first item of a list and/or a first ingredient of a recipe) and a second item (e.g., one of 668a-668h) (a second item of the list and/or a second ingredient of the recipe). In some embodiments, the second item is separate, and/or different) from the first item. In some embodiments, the first item and the second item are separate due to type, name, and/or corresponding to different portions of a recipe. In some embodiments, the second item and the first item are separate in position within the one or more times.

In some embodiments, the representation (e.g., 668) of the one or more items includes a first representation (e.g., one of 668a-668h) for the first item (e.g., a pictorial representation of the first item, an image associated with the first item, and/or a symbol corresponding to the first item) and a second representation (e.g., one of 668a-668h) for the second item (e.g., a pictorial representation of the second item, an image associated with the second item, and/or a symbol corresponding to the second item). In some embodiments, the second representation for the second item is different from the first representation for the first item. In some embodiments, the first representation for the first item is different from the second representation for the second time in one or more visual characteristics (e.g., size, type, color, and/or clarity) and/or content-based characteristics (e.g., different images and/or different type of representation). Saving multiple, separate items to one application using a single input on another application, the multiple items represented by separate representations within the one application, allows the computer system to reduce the number of interactions required to transmit information between different applications, thereby reducing the number of inputs needed to perform an operation and/or providing improved visual feedback to the user.

In some embodiments, the second user interface of the first application is the first user interface of the first application.

In some embodiments, the second user interface is different from the first user interface. In some embodiments, while (and/or after) displaying the first user interface (e.g., 608 and/or 624) of the first application, the computer system detects, via the one or more input devices, an input (e.g., 605i and/or 605j) corresponding to (e.g., directed to, at a location on, and/or associated with) the first application. In some embodiments, the input corresponding to the first application is a request to navigate to the second user interface. In some embodiments, the input corresponding to the first application is an input directed to a user-interface element (e.g., navigational control and/or user interface control). In some embodiments, in response to detecting the input corresponding to the first application, the computer system displays, via the one or more display generation components, the second user interface (e.g., 636) of the first application. In some embodiments, in response to detecting the input corresponding to the first application, the computer system ceases display of the first user interface of the first application.

In some embodiments, displaying the first user interface (e.g., that includes the one or more items) includes displaying the representation of the one or more items in a first manner (e.g., 640 at FIG. 6F) (e.g., a first format, with a first set of visual characteristics, and/or with a first amount of content). In some embodiments, displaying the second user interface (e.g., that includes the one or more items) includes displaying the representation of the one or more items in a second manner (e.g., 668 at FIG. 6K) (e.g., a second format, with a second set of visual characteristics, and/or with a second amount of content) different (e.g., different in format, different in visual characteristic, and/or different in amount of content) from the first manner. In some embodiments, the difference of the first manner and the second manner is in formatting of the one or more items such as listing the one or more items in a structured format (e.g., list and/or outline) or in a literary format (e.g., sentences and paragraphs). Displaying one or more items in a first manner within a first user interface of an application and displaying the one or more items in a second manner within a second user interface of the application allows the computer system to provide a visual cue of a transition between different user interfaces of the application and/or provide varying presentations of the one or more items to match different functionalities provided by the different user interfaces, thereby providing improved visual feedback to a user and/or performing an operation when a set of conditions has been met without requiring further user input.

In some embodiments, the one or more items (e.g., a sub list of ingredients and/or a partial list) is a subsection of (e.g., a part of and/or included within) a set of one or more items (e.g., 668a1 and 668f1 at FIG. 6L as compared to 668b1 -e1 and 668g1-h1) (e.g., a complete list and/or a total list of ingredients for a recipe). In some embodiments, the first user interface includes a representation (e.g., list and/or outline) of the set of one or more items. In some embodiments, detecting the input corresponding to the request to save the one or more items includes detecting, via the one or more input devices, an input corresponding to (e.g., directed to, selection of, and/or related to) a representation (e.g., list entry, outline entry, and/or element) of one or more items from within the representation of the set of one or more items (and/or not corresponding to one or more items of the set of one or more items). In some embodiments, the selection of the set of one or more items leaves a remaining set of one or more items not selected (e.g., ingredients not needed to purchase and/or ingredients already acquired). In some embodiments, the representation of the one or more items and the representation of the one or more other items do not include the remaining set of one or more items. In some embodiments, the second set of one or more items corresponds to needed ingredients from the larger first set of one or more items and the third set of one or more items corresponds to already acquired ingredients. Displaying a representation of one or more items (e.g., without one or more other items) from a set of one or more items in response to an input selecting the one or more items (e.g., not selecting the one or more other items) out of the set of one or more items allows the computer system to provide customization of presented content to include only content relevant to a particular user, thereby providing improved visual feedback to a user and/or performing an operation when a set of conditions has been met without requiring further user input.

In some embodiments, in response to detecting the input corresponding to the indication, the computer system ceases display of, via the one or more display generation components, a respective user interface (e.g., the first user interface and/or the second user interface) (e.g., 624) of the first application. In some embodiments, in response to detecting the input corresponding to the indication, the computer system displays another user interface of the first application different from the respective user interface of the first application. In some embodiments, ceasing display of the respective user interface of the first application includes transitioning from the respective user interface to another user interface of the first application. Ceasing display of a user interface of a first application in response to detecting an input on an indication of content saved to a second application allows the computer system to transition directly to a user interface of the second application without continuing display of the first application, thereby performing an operation when a set of conditions has been met without requiring further user input.

In some embodiments, the indication corresponding to the one or more items includes a number of items (e.g., quantity of items selected from the first application and/or quantity items to be saved to the second application) (e.g., “2 items added” in 670 at FIG. 6M) within the one or more items. In some embodiments, the indication corresponding to the one or more items includes a first quantity value (e.g., a first total and/or a first step total) corresponding to a first item of the one or more items and a second quantity value (e.g., a second total and/or a second step total) corresponding to a second item of the one or more items separate (and/or different) from the first item. In some embodiments, the second quantity value is separate (and/or different) from the first quantity value. In some embodiments, the first quantity value and the second quantity value correspond to totals of a first ingredient and a second ingredient used within a step of a recipe. Displaying a number of items saved within an indication of the items allows the computer system to provide a visual confirmation of an amount of items saved from a first application to a second application, thereby providing improved visual feedback to a user and/or performing an operation when a set of conditions has been met without requiring further user input.

In some embodiments, the indication corresponding to the one or more items includes an identification (e.g., as discussed above with respect to FIG. 6M) of the second application. In some embodiments, while displaying the identification of the second application, the computer system detects, via the one or more input devices, an input corresponding to the identification of the second application and, in response, the computer system displays, via the one or more display generation components, a user interface of the second application. Displaying an identification of an application from which items are saved within an indication of the saved items allows the computer system to provide a visual confirmation that the one or more items were saved to a correct application without opening the application, thereby providing improved visual feedback to a user.

In some embodiments, in response to detecting the input (e.g., 605l) corresponding to the request to save the one or more items (and/or directed to the second user interface), the computer system displays, via the one or more display generation components, the first user interface (e.g., 608) of the first application. In some embodiments, in response to detecting the input corresponding to the request to save the one or more items, the computer system ceases display of the second user interface of the first application. In some embodiments, in response to detecting the input corresponding to the request to save the one or more items, the computer system selectively alters one or more visual characteristics of the one or more items included in the request to save (e.g., bolding text, blurring, and/or filling in selection bubbles). Displaying a first user interface of an application in response to an input to save one or more items while displaying a second user interface of the application allows the computer system to present additional content, of the first user interface, within the application after saving the one or more items for viewing within another application, thereby performing an operation when a set of conditions has been met without requiring further user input.

In some embodiments, in response to detecting the input (e.g., 605k1 and/or 605k2) corresponding to the request to save the one or more items, the computer system displays, via the one or more display generation components, the second user interface (e.g., 636) of the first application. In some embodiments, displaying the second user interface of the first application includes displaying the one or more items, the one or more items corresponding to the request to save, and/or a subsection of the one or more items associated with the request to save. In some embodiments, in response to detecting the input corresponding to the request to save the one or more items, the computer system ceases display of the first user interface of the first application. In some embodiments, in response to detecting the input corresponding to the request to save the one or more item, the computer system selectively adjusts one or more visual characteristics of the representation of the one or more items. Displaying a user interface of an application in response to detecting an input to save one or more items while displaying the user interface allows the computer system to provide a visual cue of the one or more items saved to another application and/or provide another opportunity to save additional items after saving the one or more items, thereby performing an operation when a set of conditions has been met without requiring further user input.

In some embodiments, the user interface of the second application includes a plurality of categories (e.g., an existing set of one or more categories and/or a new set of one or more categories) (e.g., 604 and/or 690) not used by the first application. In some embodiments, the one or more items includes a plurality of items (e.g., 668). In some embodiments, the set of one or more categories corresponding to the one or more items and/or the one or more other items (e.g., includes categories that could hold respective items and/or a standard set of one or more categories that could sort the respective items). In some embodiments, after detecting the input corresponding to the indication, the computer system displays, via the one or more display generation components: a representation (e.g., 604a and/or 604b) of a first one or more items of the plurality of items (and/or a first one or more item of the one or more other items not included in the one or more items) within a first category (e.g., 604) of the plurality of categories; and a representation of a second one or more item (e.g., 690a and/or 690b) of the plurality of items (and/or a second one or more item of the one or more other items not included in the one or more items) within a second category (e.g., 690) of the plurality of categories, wherein the second one or more items are separate (and/or different) from the first one or more items, and wherein the second category is separate (and/or different) from the first category. In some embodiments, the computer system automatically sorts respective items with the first category and/or the second category. In some embodiments, the one or more items may only be sorted into the first category or the second category (e.g., categories are mutually exclusive and/or require certain characteristics to be included within the category). In some embodiments, the one or more items may be sorted into either the first category and/or the second category (e.g., categories are not mutually exclusive and/or the categories provide structure but do not prevent movement of items between differing categories). In some embodiments, displaying the user interface of the second application (and/or that includes the representation of the one or more items and the representation of one or more other items not included in the one or more items) includes categorizing the representation of the one or more items and/or the representation of one or more items not included in the one or more items into the one or more categories of the second application. Displaying a representation of a first item of a plurality of items within a first category and a representation of a second item of the plurality of items within a second category in response to detecting an input allows the computer system to provide a visual indication of a characteristic shared and/or differed between the plurality of items saved to an application, which was not indicated within an application from which the plurality of items were saved, thereby providing improved visual feedback to a user and/or performing an operation when a set of conditions has been met without requiring further user input.

In some embodiments, displaying a respective user interface (e.g., the first user interface and/or the second user interface) (e.g., 624) of the first application (and/or that includes the one or more items) includes displaying the one or more items in a first manner (e.g., 640 at FIG. 6F) (e.g., a first format and/or with a first set of visual characteristics). In some embodiments, displaying the user interface of the second application includes displaying the one or more items in a second manner (e.g., 668 at FIG. 6k) (e.g., a second format and/or with a second set of visual characteristics) different from the first manner. In some embodiments, displaying in the first manner is different from displaying in the second manner by one or more visual characteristics (e.g., size, type, color, and/or clarity) and/or content-based characteristics (e.g., different images and/or different type of representation). In some embodiments, displaying in the first manner includes displaying the one or more items within additional items, and displaying in the second manner includes displaying the one or more items without the additional items (e.g., displaying a subset of the one or more items corresponding to the request to save the one or more items). Displaying one or more items in a first manner within a first application and the one or more items in a second manner within a second application allows the computer system to provide a visual cue of the different applications containing the one or more items and/or a visual cue of differing functionality provided by the different applications, thereby providing improved visual feedback to a user and/or performing an operation when a set of conditions has been met without requiring further user input.

In some embodiments, the user interface of the second application is a first user interface (e.g., 672) of the second application. In some embodiments, the one or more other items is a first set of one or more items. In some embodiments, before displaying the representation of the one or more other items (and/or the first set of one or more items), the computer system displays, via the one or more display generation components, a second user interface (e.g., 636 at FIGS. 6K-6L) of the second application that includes a representation of a second set of one or more items (e.g., 668). In some embodiments, the second user interface of the second application is different from the first user interface of the second application. In some embodiments, the second user interface of the second application is the first user interface of the second application. In some embodiments, the computer system ceases display of the first user interface of the second application upon displaying the second user interface of the second application. In some embodiments, while displaying the representation of the second user interface of the second application, the computer system detects, via the one or more input devices, an input (e.g., 605k1 and/or 605k2) corresponding to (e.g., associated with and/or related to) a request to save the second set of one or more items, wherein, after detecting the input corresponding to the indication, the one or more other items includes (and/or are) the second set of one or more items (and/or the representation of one or more other items not included in the one or more items includes (and/or is) a representation of the second set of one or more items). In some embodiments, the second set of one or more items are not included in the one or more items. In some embodiments, in response to detecting the input corresponding to the request to save the second set of one or more items, the computer system displays an indication corresponding to the second set of one or more items. Displaying items together that are saved from different applications allows the computer system to collect related items irrespective of an application from which the items were saved (and/or irrespective of a type of the application from which the items were saved), thereby providing improved visual feedback to a user and/or performing an operation when a set of conditions has been met without requiring further user input.

In some embodiments, the one or more other items is a first set of one or more items. In some embodiments, before displaying the representation of the one or more other items (and/or the first set of one or more items), the computer system displays, via the one or more display generation components, a third user interface (e.g., 636) of the first application that includes a second set of one or more items (e.g., 668). In some embodiments, the third user interface of the first application is the first user interface of the first application and/or the second user interface of the first application. In some embodiments, the third user interface of the first application is different from the first user interface of the first application and/or the second user interface of the second application. In some embodiments, while displaying the third user interface of the first application, the computer system detects, via the one or more input devices, an input (e.g., 605l) corresponding to a request to save the second set of one or more items, and wherein, after detecting the input corresponding to the indication, the one or more other items includes (and/or are) the second set of one or more items (and/or the representation of one or more other items includes (and/or is) a representation of the second set of one or more items). In some embodiments, the second set of one or more items is the one or more items. In some embodiments, in response to detecting the input corresponding to the request to save the second set of one or more items, the computer system displays an indication corresponding to the second set of one or more items. Displaying items within a user interface of an application, different items added to the user interface using the application and one or more other applications allows the computer system to collect related items irrespective of an application from which the items were saved (and/or irrespective of a type of the application from which the items were saved), thereby providing improved visual feedback to a user and/or performing an operation when a set of conditions has been met without requiring further user input.

In some embodiments, the second application includes one or more lists (e.g., one or more previously created list of items, or more lists of items corresponding to previous requests to save one or more items, and/or one or more empty lists to be initialized with a new request to save one or more items). In some embodiments, in response to detecting the input corresponding to the request to save the one or more items, the computer system creates a new list to be added to the one or more lists (e.g., as discussed with respect to FIGS. 6L-6N) (e.g., a previously empty list, a newly created list, and/or a list corresponding to the second set of one or more items), wherein the new list is created to include the second set of one or more items (and/or the other items), and wherein, after detecting the input corresponding to the indication, the user interface of the second application includes a representation of the new list (and/or the representation of one or more other items not included in the one or more items includes the new list of one or more items and/or a representation of the new list of one or more items). In some embodiments, the new list of items does not include one or more other items due to being a newly created list until the request to save the one or more items (e.g., the computer system does not add the second set of one or more items to an existing one or more items). Creating a new list to be added to one or more lists of a second application for which to save one or more items in response to an input to save the one or more items in a first application allows the computer system to instantiate new storage locations, within different applications that provide differing functionalities, based on the one or more items to be saved and/or based on the one or more items not coinciding with items of other lists within the one or more lists, thereby performing an operation when a set of conditions has been met without requiring further user input.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the second application of process 800 can be the first application of process 700. For brevity, these details are not repeated herein.

FIG. 8 is a flow diagram illustrating a process (e.g., process 800) for automatically integrating web content into an application in accordance with some embodiments. Some operations in process 800 are, optionally, combined, the orders of some operations are, optionally, changed, and some operations are, optionally, omitted.

As described below, process 800 provides an intuitive way for automatically integrating web content into an application. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication with one or more input devices (e.g., as discussed above with respect to FIG. 6A) (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) and one or more display generation components (e.g., as discussed above with respect to FIG. 6A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system displays (802), via the one or more display generation components, a first user interface (e.g., 624) (e.g., an application user interface, a portion of a user interface, and/or web based content within an application user interface) of a first application (e.g., as discussed above with respect to FIG. 6C) (e.g., cooking application, news application, recipe application, browser application, system application, third-party application, first application containing grouped content, and/or application containing food, recipe, and/or cooking content), wherein the first user interface includes content (e.g., 624 at FIGS. 6C-6G) (e.g., a webpage, a video, an image, a recipe, media, text, listed content such as recipes, recipe steps, recipe ingredients, and/or grocery lists, web-based content, and/or application content). In some embodiments, the content corresponds to a recipe. In some embodiments, the content includes one or more and/or one or more ingredients for the recipe. In some embodiments, the content is and/or includes listed content and/or non-listed content, content of a same and/or similar category, content that shares one or more characteristics (e.g., components of a common recipe, ingredients and/or steps, and/or food content), and/or content within a common genre (e.g., list of recipes, recipe recommendations, and/or food related content).

After (and/or while) displaying the first user interface of the first application (and/or while no longer displaying the first user interface of the first application), the computer system detects (804), via the one or more input devices, an input (e.g., 605g) corresponding to (e.g., directed to, at a location of, related to, and/or associated with) a request to display a user interface of a second application (and/or a request to launch the second application) different from the first application. In some embodiments, the input corresponding to the request to display a user interface of the second application is directed to an icon of the second application. In some embodiments, the input corresponding to the request to display a user interface of the second application is directed to a user interface and/or a user interface element of the second application.

In response to detecting the input corresponding to the request to display a user interface of the second application, the computer system displays (806), via the display generation component, a second user interface (e.g., a recipe user interface, a recipes user interface, a cooking user interface, and/or an application user interface) (e.g., 602 at FIGS. 6A & 6H) of the second application (e.g., cooking application, news application, recipe application, browser application, system application, third-party application, first application containing grouped content, and/or application containing food, recipe, and/or cooking content), wherein: (808) in accordance with a determination that display of the content satisfies a first set of one or more criteria (e.g., that the content was displayed for a predefined period of time, that the computer system detected a threshold amount of interaction with the content (e.g., not including a request to add the content to the second application), and/or that an attention of a user of the computer system exceeded a threshold amount of attention with the content), the second user interface includes an indication (e.g., an identification and/or a representation) (e.g., 650, 622, and/or 644) of the content; and in accordance with (810) a determination that display of the content satisfies a second set of one or more criteria, the second user interface does not include the indication of the content (and/or forgoes display of a portion of the content), wherein the second set of one or more criteria is different from the first set of one or more criteria. In some embodiments, the first set of one or more criteria does not include a criterion based on detecting an input corresponding to a request to add the content to the second application. In some embodiments, the first set of one or more criteria includes a criterion that is satisfied based on an amount of time that the content was displayed, whether the content has been previously displayed, whether the content has been displayed on another computer system separate from the computer system, whether the content has been displayed within and/or connected to another application different from the first application and/or the second application, and/or whether one or more portions of the content matches content saved on the computer system and/or within another application different from the first application and/or the second application. In some embodiments, the second application is different in type (e.g., web application, website, system application and/or third-party application), name, and/or contained content (e.g., list content, text content, multimedia content, and/or mixed content) than the first application. In some embodiments, the indication of the content includes a portion of the content. In some embodiments, the indication of the content is the content. In some embodiments, the indication of the content includes a title of the content. In some embodiments, the indication of the content includes an indication of when the content was displayed via the first application. In some embodiments, in response to detecting the input corresponding to the request to display a user interface of the second application, the computer system ceases displaying a user interface of the first application, such as the first user interface. In some embodiments, in response to detecting the input corresponding to the request to display a user interface of the second application, the computer system continues display of a portion of the first user interface of the first application. In some embodiments, the second user interface of the second application includes one or more user interface elements from the second application (e.g., content previously saved and/or viewed on the second application and/or one or more other applications different from the second application). Selectively including an indication of content within a user interface of a second application based on satisfaction of a set of criteria while displaying the content within a first application allows the computer system to tailor inclusions into a list of content based on interactions with the content within different applications without requiring explicit inputs to add the content to the list of content, thereby performing an operation when a set of conditions has been met without requiring further user input.

In some embodiments, the first set of one or more criteria includes a criterion that is satisfied when the content (e.g., 624 at FIGS. 6C-6G) is displayed (and/or the first user interface that includes the content is displayed) for greater than (e.g., surpasses and/or goes over) a threshold amount of time (e.g., as discussed above with respect to FIG. 6A). In some embodiments, the amount of time begins when the computer system displays the first user interface of the first application and/or when the computer system displays the content within the first user interface of the first application. In some embodiments, the first user interface of the first application includes additional content, and the amount of time does not include when the computer system displays the additional content. Automatically adding content to another application when the content is displayed for greater than a threshold amount of time allows the computer system to identify when content should be saved for later without explicit requests being made, thereby performing an operation when a set of conditions has been met without requiring further user input.

In some embodiments, the content includes a first portion (e.g., 624 at FIG. 6C) of the content and a second portion (e.g., 624 at FIG. 6D) of the content separate (and/or different) from the first portion of the content. In some embodiments, the first set of one or more criteria includes a criterion that is satisfied when the first portion of the content and the second portion of the content are displayed (e.g., as discussed above with respect to FIG. 6A) (e.g., an amount of the content scrolled, navigated, and/or displayed). In some embodiments, first set of one or more criteria includes a criterion that is satisfied when all portions of the content are displayed. In some embodiments, the content includes a third portion of the content, separate from the first portion of the content and the second portion of the content, and the first set of one or more criteria includes a criterion that is satisfied when a subsection of the content (e.g., satisfied when the first portion of the content and the second portion of the content are displayed irrespective of the third portion of the content). Automatically adding content to another application when the content is scrolled a certain amount allows the computer system to identify when content should be saved for later without explicit requests being made, thereby performing an operation when a set of conditions has been met without requiring further user input.

In some embodiments, the first set of one or more criteria includes a criterion that is satisfied when a threshold amount of media content (e.g., 638) included in the content is watched (e.g., as discussed above with respect to FIG. 6A) (e.g., percentage of playback of video content and/or number of images viewed within the content). In some embodiments, the threshold amount of media content watched corresponds to a single media item (e.g., watching all of a video, viewing an image for a period of time, and/or fully displaying an image). In some embodiments, the threshold amount of media content watched corresponds to one or more media items within the media content (e.g., watching a majority of videos within the media content, viewing more than one image of the media content, and/or viewing a percentage of all the media content). Automatically adding content to another application when a threshold amount of the content is watched allows the computer system to identify when content should be saved for later without explicit requests being made, thereby performing an operation when a set of conditions has been met without requiring further user input.

In some embodiments, the first set of one or more criteria includes a criterion that is satisfied when culinary content (e.g., 640 and/or 628) (e.g., recipes and/or food related content) included in the content aligns with (e.g., corresponds to, is associated with, is compatible with, and/or is included in) one or more culinary characteristics (e.g., diet, type of food, and/or food restrictions) corresponding to (e.g., preferred by and/or specified by) a user (e.g., as discussed above with respect to FIG. 6A). In some embodiments, the one or more culinary characteristics corresponding to the user are one or more user defined preferences such as dietary restrictions, allergies, preferred meal type, preferred meal size, and/or style of preparation. In some embodiments, the one or more culinary characteristics corresponding to the user are one or more user specific capabilities such as: owning an oven, grill, fryer, and/or other pieces of kitchen equipment, time allotment for cooking, and/or ability to buy one or more types of ingredients. In some embodiments, the computer system specifies the one or more culinary characteristics corresponding to the user based on one or more habits associated with the user such as meal type, cooking time, cuisine, and/or number of servings. Automatically adding content to another application when the content aligns with one or more culinary characteristics of a user allows the computer system to identify when content should be saved for later without explicit requests being made, thereby performing an operation when a set of conditions has been met without requiring further user input.

In some embodiments, the first set of one or more criteria includes a criterion that is satisfied when a user directs attention (e.g., the content is displayed, the content is an active window for a threshold amount of time, a user interacts with the content by a particular amount, the content is viewed prominently, a user increases the size and/or zooms in on the content, and/or views only the content) to the content for a threshold amount of time (e.g., as discussed above with respect to FIG. 6A). In some embodiments, the computer system detects, via the one or more input devices, an input corresponding to a location of the user's attention (e.g., user's gaze at a position corresponding to the content and/or a user input at a location corresponding to the content). In some embodiments, the computer system detects a scroll input and/or swipe input, and the computer system detects the user directing attention to the content by continuing to detect the scroll input and/or swipe input at a location of the content (e.g., a user stopping mid scroll to view the content and/or slowing an input to view the content). Automatically adding content to another application when a user directs attention to the content for a particular amount of time allows the computer system to identify when content should be saved for later without explicit requests being made, thereby performing an operation when a set of conditions has been met without requiring further user input.

In some embodiments, the first application is a browser application (e.g., as discussed above with respect to FIG. 6A) (e.g., an application that obtains content from web-based, server-based, and/or other application-based content and/or an application that includes content from one or more sources). In some embodiments, the browser application is a system application (e.g., an application provided by the computer system rather than a third-party and/or an application with additional system-based functionality and/or security).

In some embodiments, the first user interface of the first application includes a webpage (e.g., 624 at FIGS. 6C-6H) (and/or that includes the content). In some embodiments, the webpage includes the content (e.g., as discussed above with respect to FIG. 6A). In some embodiments, the webpage includes one or more portions of the content including the content (e.g., the content corresponds to a recipe within a larger series of content such as an author information section, webpage information section, and/or one or more other pieces of content). In some embodiments, the webpage is the content (e.g., the content encompasses the entire webpage and/or the webpage is only a recipe).

In some embodiments, the content is (and/or includes) video content (e.g., 638). In some embodiments, the video content is an embedded video player that obtains content from another source such as another webhost and/or server. In some embodiments, the video content includes ones or more controls for adjusting playback of the video content. In some embodiments, the video content is controlled by the computer system (e.g., the computer system manages playback of the video content and/or the computer system displays video data sent by a third-party such as a webhost and/or server).

In some embodiments, the content is (and/or includes) text content (e.g., 640 and/or 628) (e.g., one or more portions of text content such as characters, sentences, and/or paragraphs). In some embodiments, the text content is structured content (e.g., an outline, list, and/or specifically formatted text content).

In some embodiments, the content is first content (e.g., 644). In some embodiments, the first content is added to a set of content (e.g., 630 at FIGS. 6A & 6H) (e.g., a list of recipes and/or set of one or more food related pieces of content) within the second application in accordance with a determination that display of the content satisfies the first set of one or more criteria (e.g., as discussed above with respect to FIG. 6A). In some embodiments, before displaying the second user interface of the second application, the computer system displays, via the one or more display generation component, a third user interface (e.g., an application user interface, a portion of a user interface, and/or web based content within an application user interface) of the second application (e.g., an alternative version of 608 at FIG. 6I), wherein the third user interface of the second application is different from the second user interface of the second application. In some embodiments, the third user interface includes curated content (e.g., suggested recipes, recently added recipes, and/or additional recipes not searched for directly) and/or content obtained from a third-party (e.g., one or more recipes and/or dishes corresponding to a request for recipes and/or dishes). In some embodiments, while displaying the third user interface of the second application, the computer system detects, via the one or more input devices, an input corresponding to (e.g., directed to, at a location of, related to, and/or associated with) (1) a request to add second content (e.g., a webpage, a video, an image, a recipe, media, text, listed content such as recipes, recipe steps, recipe ingredients, and/or grocery lists, web-based content, and/or application content) to the set of content within the second application and (2) the third user interface (e.g., 658) of the second application, wherein, after detecting the input corresponding to the request to add the second content to the set of content within the second application and in accordance with the determination that display of the content satisfies the first set of one or more criteria, the second user interface concurrently (e.g., alongside, with, at the same time as, and/or within a shared user-interface object) includes an indication (e.g., 650) of the second content and the indication (e.g., 644) of the first content, and wherein the indication of the second content is separate from the indication of the first content. In some embodiments, the indication of the second content is separate from the indication of the first content due to the first content being previously added, added via another application, added via another user interface (e.g., website and/or application), and/or automatically added. Concurrently displaying an indication of first content, from a first application, along with an indication of second content, saved from a second application, within a list of content displayed within the second application after detecting an input to add the second content allows the computer system to collect content added from different applications in one place, thereby providing improved visual feedback to the user and/or performing an operation when a set of conditions has been met without requiring further user input.

In some embodiments, the content is first content. In some embodiments, before displaying the second user interface of the second application, the computer system displays, via the one or more display generation components, a fourth user interface (e.g., an application user interface, a portion of a user interface, and/or web-based content within an application user interface) of the second application that includes second content (e.g., a webpage, a video, an image, a recipe, media, text, listed content such as recipes, recipe steps, recipe ingredients, and/or grocery lists, web-based content, and/or application content) (e.g., an alternative version of 624 for 694a) different from the first content. In some embodiments, the fourth user interface includes curated content (e.g., suggested recipes, recently added recipes, and/or additional recipes not searched for directly) and/or content obtained from a third-party (e.g., one or more recipes and/or dishes corresponding to a request for recipes and/or dishes). In some embodiments, after displaying the fourth user interface of the second application that includes the second content, the computer system detects, via the one or more input devices, an input (e.g., 605g) corresponding to a request to display a user interface of the second application, wherein, after detecting the input corresponding to the request to display a user interface of the second application and in accordance with a determination that display of the second content satisfies the first set of one or more criteria, the second user interface concurrently (e.g., alongside, with, at the same time as, and/or within a shared user-interface object) includes the indication of the first content and the indication of the second content, and wherein the indication of the second content is separate from the indication of the first content. In some embodiments, the indication of the second content is separate from the indication of the first content due to the first content being previously added, added via another application, added via another user interface (e.g., website and/or application), and/or automatically added. Automatically adding different content from different applications to one application based on display of the different content allows the computer system to automatically save content that it determines a user might want to review later, thereby providing improved visual feedback to a user and/or performing an operation when a set of conditions has been met without requiring further user input.

In some embodiments, the content is first content (e.g., 644). In some embodiments, the first content is added to a set of content (e.g., 630) (e.g., a list of recipes and/or set of one or more food related pieces of content) within the second application in accordance with a determination that display of the content satisfies the first set of one or more criteria. In some embodiments, before displaying the second user interface of the second application, the computer system displays, via the one or more display generation component, a second user interface (e.g., an application user interface, a portion of a user interface, and/or web-based content within an application user interface) (e.g., an alternative version of 624 for 694a) of the first application. In some embodiments, the second user interface of the first application is the first user interface of the first application. In some embodiments, the second user interface of the first application includes curated content (e.g., suggested recipes, recently added recipes, and/or additional recipes not searched for directly) and/or content obtained from a third-party (e.g., one or more recipes and/or dishes corresponding to a request for recipes and/or dishes). In some embodiments, while displaying the second user interface of the second application, the computer system detects, via the one or more input devices, an input corresponding to (e.g., directed to, at a location of, related to, and/or associated with) (1) a request to add second content (e.g., a webpage, a video, an image, a recipe, media, text, listed content such as recipes, recipe steps, recipe ingredients, and/or grocery lists, web-based content, and/or application content) to the set of content within the second application and (2) the second user interface of the first application (e.g., as discussed above with respect to FIG. 6A), wherein, after detecting the input corresponding to the request to add the second content to the set of content within the second application and in accordance with the determination that display of the content satisfies the first set of one or more criteria, the second user interface concurrently (e.g., alongside, with, at the same time as, and/or within a shared user-interface object) includes an indication (e.g., 650) of the second content and the indication (e.g., 644) of the first content, and wherein the indication of the second content is separate from the indication of the first content. In some embodiments, the indication of the second content is separate from the indication of the first content due to the first content being previously added, added via another application, added via another user interface (e.g., website and/or application), and/or automatically added. Automatically adding content from one application to a list of content from another application, the list of content including content manually added to the list of content using the one application allows the computer system to gather content automatically and manually saved, thereby providing improved visual feedback to the user and/or performing an operation when a set of conditions has been met without requiring further user input.

In some embodiments, the content is first content (e.g., 644). In some embodiments, before displaying the second user interface of the second application, the computer system displays, via the one or more display generation components, a user interface (e.g., an application user interface, a portion of a user interface, and/or web-based content within an application user interface) of a third application that includes second content (e.g., as discussed above with respect to FIG. 6A) (e.g., a webpage, a video, an image, a recipe, media, text, listed content such as recipes, recipe steps, recipe ingredients, and/or grocery lists, web-based content, and/or application content) different from the first content. In some embodiments, the third application is different from the first application and the second application. In some embodiments, the third application is a content application such as a recipe application (e.g., recipe blog, recommended recipe application, diet specific application, and/or health based application) and/or media application (e.g., video application that includes recipe guides, cooking tips, and/or food based content and/or text application that includes recipes, articles, and/or food related news). In some embodiments, after displaying the user interface of the third application that includes the second content, the computer system detects, via the one or more input devices, an input (e.g., 605g) corresponding to a request to display a user interface of the second application. In some embodiments, after detecting the input corresponding to the request to display a user interface of the second application and in accordance with a determination that display of the second content satisfies the first set of one or more criteria, the second user interface concurrently (e.g., alongside, with, at the same time as, and/or within a shared user-interface object) includes the indication of the content and the indication of the second content. In some embodiments, the indication of the second content is separate from the indication of the first content. In some embodiments, the indication of the second content is separate from the indication of the first content due to the first content being previously added, added via another application, added via another user interface (e.g., website and/or application), and/or automatically added. Automatically adding different content from different applications to a list of content of another application allows the computer system to automatically save content from various applications that it determines a user might want to review later, thereby providing improved visual feedback to a user and/or performing an operation when a set of conditions has been met without requiring further user input.

In some embodiments, the second user interface includes one or more indications of content (e.g., 650, 644, and/or 622) (e.g., portions of content and/or representations of content). In some embodiments, while displaying the second user interface of the second application, the computer system detects, via the one or more input devices, an input corresponding (e.g., directed to, at a location of, related to, and/or associated with) to a request to filter the one or more indications of content (e.g., as discussed above with respect to FIG. 6A). In some embodiments, the computer system filters the one or more indications of content by removing one or more indications of content that do not correspond to a filter criterion. In some embodiments, the computer system filters the one or more indications of the content by sorting the one or more indications of content in an order corresponding to relevance to a filter criterion. In some embodiments, in response to detecting the input corresponding to the request to filter the one or more indications of content, the computer system maintains display of, via the one or more display generation components, a first set (e.g., 622 and/or 650) of one or more indications of content of the one or more indications of content (e.g., a first item, a first recipe, and/or a first dish of a set of one or more items, recipes, and/or dishes). In some embodiments, in response to detecting the input corresponding to the request to filter the one or more indications of content, the computer system ceases display of, via the one or more display generation components, a second set of one or more indications of content of the one or more indication of the content (e.g., as discussed above with respect to FIG. 6A), wherein the first set of one or more indications of content includes different (and/or separate from) content than the second set of one or more indications of content (e.g., the first set of one or more indications of content includes one or more pieces of content not included in the second set of one or more indications of content and/or the first set of one or more indications of content is mutually exclusive from the second set of one or more indication of content). Enabling a list of content that includes content automatically added via one or more other applications to be filtered allows the computer system to cater content displayed to a user, thereby providing improved visual feedback to a user and/or performing an operation when a set of conditions has been met without requiring further user input.

In some embodiments, while displaying the indication of the content, the computer system detects, via the one or more input devices, an input (e.g., 605h) corresponding to (e.g., directed to, at a location of, related to, and/or associated with) the indication of the content. In some embodiments, the indication of the content includes a representation of the content, and the input is directed to the representation of the content. In some embodiments, in response to detecting the input corresponding to the indication of the content, the computer system displays, via the one or more display generation components, a portion (e.g., 608 at FIG. 6I) of the content (e.g., a recipe preview, recipe title, recipe steps, and/or recipe ingredients). In some embodiments, displaying the portion of the content includes displaying a step of one or more steps of a recipe, and the computer system transitions between the one or more steps of the recipe based on input. In some embodiments, in response to detecting the indication of the content, the computer system ceases display of the indication of the content. Displaying a portion of content within an application in response to detecting an input on an indication of the content within the application allows the computer system to provide the content without requiring a user return to an initial source of the content (e.g., a different content application), thereby reducing the number of inputs needed to perform an operation.

In some embodiments, while displaying the first user interface of the first application, displaying the content includes displaying the content in a first manner (e.g., 624 at FIG. 6C) (e.g., with one or more visual characteristics such as font, size, emphasis, and/or formatting and/or one or more content based characteristics such as quantity of text, inclusions of content, and/or removal of content). In some embodiments, after detecting the input corresponding to the indication of the content, displaying the portion of the content includes displaying the portion of the content in a second manner (e.g., 624 at FIG. 6I) (e.g., with one or more altered visual characteristics such as font, size, emphasis, and/or formatting and/or one or more altered content based characteristics such as quantity of text, inclusions of content, and/or removal of content) different from the first manner. In some embodiments, the second manner is different from the first manner in one or more characteristics (e.g., one or more visual and/or content-based characteristics) and/or presentation (e.g., pagination, separation of content, and/or manner of navigation). Displaying content in different manners depending on whether the content is displayed in an application that it was originally saved from or an application that automatically collects content allows the computer system to cater its display of content to a current usage rather than always displaying it in the same manner, thereby providing improved visual feedback to the user and/or performing an operation when a set of conditions has been met without requiring further user input.

In some embodiments, while displaying the portion of the content, the computer system displays, via one or more display generation components, one or more navigation controls (e.g., as discussed above with respect to FIG. 6I) (e.g., next, back, close, and/or jump to), wherein the first user interface of the first application does not include the one or more navigational controls (e.g., the first user interface of the first application and/or the content do not provide the one or more navigation controls). In some embodiments, the computer system provides the one or more navigation controls and/or the computer system sources the one or more navigation control from an application. In some embodiments, while displaying the portion of the content and the one or more navigational controls, the computer system detects an input corresponding to the one or more navigational controls, and in response, the computer system displays another portion of the content different from the portion of the content. Displaying one or more navigation controls while displaying a portion of content within an application allows the computer system to provide a visual indication that the portion of content is interactable within the application as compared to an initial source of the content (e.g., a different content application) and/or that the portion of content is a part of a series of portions of content, thereby providing improved visual feedback to the user and/or performing an operation when a set of conditions has been met without requiring further user input.

In some embodiments, the indication of the content includes an identification (e.g., name and/or signifying representation) (e.g., as discussed above with respect to FIG. 6A) of the first application. In some embodiments, the computer system displays a user interface of the first application in response to detecting an input directed to the identification of the first application.

In some embodiments, the indication of the content includes a title (e.g., 644, 622, and/or 650) associated with (e.g., obtained from, connected to, and/or signifying) the content.

In some embodiments, the content includes one or more images (e.g., image in 624 at FIG. 6C) (e.g., a recipe preview, one or more images corresponding to steps of a recipe, and/or one or more images of ingredients used in a recipe). In some embodiments, the indication of the content includes an image (e.g., 644, 622, and/or 650) from the one or more images. In some embodiments, the computer system selects (e.g., based on analysis of the recipe and/or relevance) the image of the one or more images as a representative image for the recipe. In some embodiments, the content includes a marking and/or identifier corresponding to the image of the one or more images to show that the image is representative of the recipe.

In some embodiments, the indication of the content includes an identification of an author (e.g., recipe author, website author, and/or content owner) of the content (e.g., as discussed above with respect to FIG. 6A). In some embodiments, the identification of the author corresponds to an entity and/or organization responsible for the recipe (e.g., a recipe blog name, food show name, and/or new publisher name) and/or a particular subject who authored the recipe.

Note that details of the processes described above with respect to process 800 (e.g., FIG. 8) are also applicable in an analogous manner to the processes described herein. For example, process 700 optionally includes one or more of the characteristics of the various processes described herein with reference to process 800. For example, the one or more items of process 700 can be included in the content of process 800. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the manipulation of web-based content. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for manipulating web-based content. Accordingly, use of such personal information data enables users to have a computer system perform operations for manipulating web-based content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more input devices and one or more display generation components:
displaying, via the one or more display generation components, a first user interface of a first application, wherein the first user interface includes one or more items;
while displaying, via the one or more display generation components, a second user interface of the first application, detecting, via the one or more input devices, an input (1) directed to the second user interface and (2) corresponding to a request to save the one or more items;
in response to detecting the input corresponding to the request to save the one or more items, displaying, via the one or more display generation components, an indication corresponding to the one or more items;
while displaying the indication corresponding to the one or more items, detecting, via the one or more input devices, an input corresponding to the indication; and
in response to detecting the input corresponding to the indication, displaying, via the one or more display generation components, a user interface of a second application different from the first application, wherein the user interface of the second application includes:
a representation of the one or more items; and
a representation of one or more other items not included in the one or more items.

2. The method of claim 1, wherein:
the first user interface corresponds to a recipe;
the one or more items are one or more ingredients of the recipe; and
the input corresponding to the request to save the one or more items is a request to add the one or more ingredients of the recipe to a grocery list.

3. The method of claim 1, wherein the first application is a content application, and wherein the second application is a list application.

4. The method of claim 1, further comprising:
while displaying the indication corresponding to the one or more items, detecting a threshold amount of time has passed without detecting, via the one or more input devices, an input corresponding to the indication corresponding to the one or more items; and
in response to detecting the threshold amount of time has passed, ceasing display of, via the one or more display generation components, the indication corresponding to the one or more items.

5. The method of claim 1, wherein the indication corresponding to the one or more items corresponds to an operating system, and wherein the indication corresponding to the one or more items includes content from the second application.

6. The method of claim 1, wherein the indication corresponding to the one or more items is concurrently displayed with a third user interface of the first application.

7. The method of claim 6, wherein the indication corresponding to the one or more items is displayed on top of the third user interface of the first application.

8. The method of claim 6, wherein the third user interface of the first application is the second user interface of the first application.

9. The method of claim 1, wherein the one or more items includes a first item and a second item, and wherein the second item is separate from the first item.

10. The method of claim 9, wherein the representation of the one or more items includes a first representation for the first item and a second representation for the second item, and wherein the second representation for the second item is different from the first representation for the first item.

11. The method of claim 1, wherein the second user interface of the first application is the first user interface of the first application.

12. The method of claim 1, wherein the second user interface is different from the first user interface, the method further comprising:
while displaying the first user interface of the first application, detecting, via the one or more input devices, an input corresponding to the first application; and
in response to detecting the input corresponding to the first application, displaying, via the one or more display generation components, the second user interface of the first application.

13. The method of claim 12, wherein displaying the first user interface includes displaying the representation of the one or more items in a first manner, and wherein displaying the second user interface includes displaying the representation of the one or more items in a second manner different from the first manner.

14. The method of claim 1, wherein the one or more items is a subsection of a set of one or more items, wherein the first user interface includes a representation of the set of one or more items, and wherein detecting the input corresponding to the request to save the one or more items includes detecting, via the one or more input devices, an input corresponding to a representation of one or more items from within the representation of the set of one or more items.

15. The method of claim 1, further comprising:
in response to detecting the input corresponding to the indication, ceasing display of, via the one or more display generation components, a respective user interface of the first application.

16. The method of claim 1, wherein the indication corresponding to the one or more items includes a number of items within the one or more items.

17. The method of claim 1, wherein the indication corresponding to the one or more items includes an identification of the second application.

18. The method of claim 1, further comprising:
in response to detecting the input corresponding to the request to save the one or more items, displaying, via the one or more display generation components, the first user interface of the first application.

19. The method of claim 1, further comprising:
in response to detecting the input corresponding to the request to save the one or more items, displaying, via the one or more display generation components, the second user interface of the first application.

20. The method of claim 1, wherein the user interface of the second application includes a plurality of categories not used by the first application, wherein the one or more items includes a plurality of items, the method further comprising:
after detecting the input corresponding to the indication, displaying, via the one or more display generation components:
a representation of a first one or more items of the plurality of items within a first category of the plurality of categories; and
a representation of a second one or more item of the plurality of items within a second category of the plurality of categories, wherein the second one or more items are separate from the first one or more items, and wherein the second category is separate from the first category.

21. The method of claim 1, wherein displaying a respective user interface of the first application includes displaying the one or more items in a first manner, and wherein displaying the user interface of the second application includes displaying the one or more items in a second manner different from the first manner.

22. The method of claim 1, wherein the user interface of the second application is a first user interface of the second application, and wherein the one or more other items is a first set of one or more items, the method further comprising:
before displaying the representation of the one or more other items, displaying, via the one or more display generation components, a second user interface of the second application that includes a representation of a second set of one or more items; and
while displaying the representation of the second user interface of the second application, detecting, via the one or more input devices, an input corresponding to a request to save the second set of one or more items, wherein, after detecting the input corresponding to the indication, the one or more other items includes the second set of one or more items.

23. The method of claim 1, wherein the one or more other items is a first set of one or more items, the method further comprising:
before displaying the representation of the one or more other items, displaying, via the one or more display generation components, a third user interface of the first application that includes a second set of one or more items; and
while displaying the third user interface of the first application, detecting, via the one or more input devices, an input corresponding to a request to save the second set of one or more items, and wherein, after detecting the input corresponding to the indication, the one or more other items includes the second set of one or more items.

24. The method of claim 23, wherein the second application includes one or more lists, the method further comprising:
in response to detecting the input corresponding to the request to save the one or more items, creating a new list to be added to the one or more lists, wherein the new list is created to include the second set of one or more items, and wherein, after detecting the input corresponding to the indication, the user interface of the second application includes a representation of the new list.

25. A non-transitory computer-readable storage medium storing one or more programs configured to be executed by one or more processors of a computer system that is in communication with one or more input devices and one or more display generation components, the one or more programs including instructions for:
displaying, via the one or more display generation components, a first user interface of a first application, wherein the first user interface includes one or more items;
while displaying, via the one or more display generation components, a second user interface of the first application, detecting, via the one or more input devices, an input (1) directed to the second user interface and (2) corresponding to a request to save the one or more items;
in response to detecting the input corresponding to the request to save the one or more items, displaying, via the one or more display generation components, an indication corresponding to the one or more items;
while displaying the indication corresponding to the one or more items, detecting, via the one or more input devices, an input corresponding to the indication; and
in response to detecting the input corresponding to the indication, displaying, via the one or more display generation components, a user interface of a second application different from the first application, wherein the user interface of the second application includes:
a representation of the one or more items; and
a representation of one or more other items not included in the one or more items.

26. A computer system configured to communicate with one or more input devices and one or more display generation components, the computer system comprising:
one or more processors; and
memory storing one or more programs configured to be executed by the one or more processors, the one or more programs including instructions for:
displaying, via the one or more display generation components, a first user interface of a first application, wherein the first user interface includes one or more items;
while displaying, via the one or more display generation components, a second user interface of the first application, detecting, via the one or more input devices, an input (1) directed to the second user interface and (2) corresponding to a request to save the one or more items;
in response to detecting the input corresponding to the request to save the one or more items, displaying, via the one or more display generation components, an indication corresponding to the one or more items;
while displaying the indication corresponding to the one or more items, detecting, via the one or more input devices, an input corresponding to the indication; and
in response to detecting the input corresponding to the indication, displaying, via the one or more display generation components, a user interface of a second application different from the first application, wherein the user interface of the second application includes:
a representation of the one or more items; and
a representation of one or more other items not included in the one or more items.
